(19) United States
(12) Patent Application Publication
(10) Pub. No.: US 2012/0288777 A1
(43) Pub. Date: Nov. 15, 2012

(54) METHOD OF CONTROLLING FUEL CELL SYSTEM

(75) Inventors: Shuichi Kazuno, Utsunomiya-shi (JP); Hibiki Saeki, Utsunomiya-shi (JP); Daishi Igarashi, Utsunomiya-shi (JP)

(73) Assignee: HONDA MOTOR CO., LTD, Tokyo (JP)

(21) Appl. No.: 13/462,392

(22) Filed: May 2, 2012

(30) Foreign Application Priority Data
May 12, 2011 (JP) 2011-107144
Sep. 12, 2011 (JP) 2011-197777

(51) Int. Cl. H01M 8/04

(52) U.S. Cl. 429/432

(57) ABSTRACT

In an FC system of an FC vehicle, if a control device determines that conditions of an idling power generation suppression mode of a FC are satisfied, the control device sets the voltage of the FC to a predetermined voltage value outside a voltage range where an oxidation-reduction of platinum proceeds, and controls a reactant gas supply apparatus to change a supply amount of air such that the FC has an output in accordance with the electric power required by a load.

### CROSS-REFERENCE TO RELATED APPLICATION

This application is based upon and claims the benefit of priority from Japanese Patent Applications No. 2011-107144 filed on May 12, 2011 and No. 2011-197777 filed on Sep. 12, 2011, of which the contents are incorporated herein by reference.

### BACKGROUND OF THE INVENTION

1. Field of the Invention

The present invention relates to a method of controlling a fuel cell system including a fuel cell, an energy storage device capable of storing electric power supplied from the fuel cell, and a load to which electric power is supplied from at least one of the fuel cell and the energy storage device.

2. Description of the Related Art

In a conventional technique, a fuel cell system for suppressing degradation of a fuel cell used in a fuel cell vehicle or the like is proposed, and in the fuel cell system, power generation is performed in a manner that the oxidation reduction electrical potential is avoided (Japanese Laid Open Patent Publication No. 2011-015580 (hereinafter referred to as “JP2011-015580A”)). In the fuel cell system of JP2011-015580A, if power required in power generation (required load) (P*) is less than a predetermined threshold (Pthr), the fuel cell system enters a power generation suspension mode by stopping supply of gases to the fuel cell. In the power generation suspension mode, the voltage of the fuel cell is set to a voltage less than the open circuit voltage (OCV), and minute current is produced for preventing degradation of the fuel cell, while achieving improvement in the efficiency in the vehicle (See abstract, paragraphs [0045] to [0047], FIGS. 2 and 4 therein). During the power generation suspension mode, a battery (74) is charged with excessive electric power. The battery functions as a storage source of the excessive electric power, a regenerative energy storage source at the time of regenerative braking, and an energy buffer when load fluctuation occurs due to acceleration or deceleration of the fuel cell vehicle (paragraph [0036] therein).

### SUMMARY OF THE INVENTION

As described above, in JP2011-015580A, after the excessive electric power in the power generation suspension mode is stored in the battery, the stored electric power is used for acceleration of the vehicle. Thus, if the frequency of charging/discharging of the battery is increased, electric power loss occurs due to such charging/discharging, and the output efficiency in the fuel cell system may be lowered undesirably.

The present invention has been made to take the problems of this type into account, and an object of the present invention is to provide a method of controlling a fuel cell system, which makes it possible to suppress degradation of a fuel cell, and improve the output efficiency in the fuel cell system as a whole.

A method of controlling a fuel cell system according to the present invention is provided, the fuel cell system including a fuel cell, an energy storage device for storing electric power supplied from the fuel cell, a load to which electric power is supplied from at least one of the fuel cell and the energy storage device, a converter for adjusting the voltage of the fuel cell, a control device for controlling electric power supplied from the fuel cell and the energy storage device to the load based on electric power required by the load, a reactant gas supply apparatus for supplying a reactant gas to the fuel cell. In the method, if the control device determines that a condition of an idling power generation suppression mode of the fuel cell is satisfied, the control device sets the voltage of the fuel cell to a predetermined voltage value outside a voltage range where an oxidation-reduction of platinum proceeds, and controls the reactant gas supply apparatus to change a supply amount of air such that the fuel cell has an output in accordance with the electric power required by the load.

In the present invention, while the voltage of the fuel cell is kept at a constant level outside the voltage range where an oxidation-reduction of platinum proceeds, the output current of the fuel cell is changed in accordance with the load. Therefore, during the idling power generation suppression mode of the fuel cell, degradation of the fuel cell is prevented, and unnecessary power generation can be suppressed. Accordingly, charging/discharging loss in the energy storage device can be reduced, and improvement in the output efficiency in the fuel cell system is achieved.

The predetermined voltage value may be above or below the voltage range where the oxidation-reduction proceeds.

If an amount of electric power stored in the energy storage device is a target energy storage amount or less, the voltage of the fuel cell may be kept at the predetermined voltage value until the amount of electric power stored in the energy storage device reaches the target energy storage amount, and a gas in the fuel cell may be kept in a rich state. In the structure, since the voltage of the fuel cell is set to the predetermined voltage value outside the voltage range where an oxidation-reduction of platinum proceeds, degradation of the fuel cell can be prevented. Additionally, since the gas in the fuel cell is kept in a rich state, the amount of electric power generated in the fuel cell is increased, and the energy storage device is charged with the excessive electric power. Thus, the amount of electric power stored in the energy storage device can be kept at the target energy storage amount.

The fuel cell system may be mounted in a vehicle. The load may include a regenerative motor and an auxiliary device. If the control device determines that the condition of the idling power generation suppression mode is satisfied, the control device may set the voltage of the fuel cell to the predetermined voltage value and control the reactant gas supply apparatus to change a supply amount of air such that the fuel cell has an output in accordance with the electric power required by the auxiliary device.

If the velocity of the vehicle or the rotation number of the motor is a predetermined threshold value or less, the control device may set the voltage of the fuel cell to the supply apparatus to change a supply amount of air such that the fuel cell has an output in accordance with the electric power required by the auxiliary device.

A method of controlling a fuel cell system of the present invention, the fuel cell system including a fuel cell, an energy storage device for storing electric power supplied from the fuel cell, a load to which electric power is supplied from at least one of the fuel cell and the energy storage device, a converter for adjusting the voltage of the fuel cell, a control device for controlling electric power supplied from the fuel cell and the energy storage device to the load based on electric power required by the load, and a reactant gas supply apparatus for supplying a reactant gas to the fuel cell. In the method, the control device adjusts the voltage of the fuel cell to selectively perform a normal mode for controlling electric power supplied from the fuel cell to the load and an idling power generation suppression mode for limiting power generation of the fuel cell during low-load operation of the fuel cell system; in the idling power generation suppression mode, the control device sets the voltage of the fuel cell to a predetermined voltage value outside a voltage range where an oxidation-reduction of platinum proceeds, and performs low-efficiency power generation to limit a supply amount of the reactant gas; and at the time of transition from the idling power generation suppression mode to the normal mode as a result of increase in electric power required by the load, the control device increases a supply amount of the reactant gas supplied to the fuel cell in accordance with increase in the electric power required by the load, and decreases the voltage of the fuel cell set to the predetermined voltage value, from the predetermined voltage value in accordance with increase in the electric power required by the load.

In the present invention, operation of the fuel cell can transition rapidly from the idling state to the normal state. That is, in general, in the case where concentration of the reactant gas is constant, in order to increase electric power generated in the fuel cell, the output voltage of the fuel cell needs to be decreased, and the output current of the fuel cell needs to be increased. Further, in the case where the output voltage and the output current of the fuel cell are kept unchanged, by increasing concentration of the reactant gas, electric power generated in the fuel cell can be increased. In the present invention, at the time of transition from the idling power generation suppression mode to the normal mode, the amount of the supplied reactant gas is increased in accordance with the increase in the electric power required by the load, and the voltage of the fuel cell is decreased in accordance with the increase in the electric power required by the load. Thus, since it is possible to increase concentration of the reactant gas in accordance with the increase in the electric power required by the load, and decrease the output voltage of the fuel cell, the fuel cell can transition rapidly from the idling state to the normal state (It should be noted that it is only necessary to perform operation of increasing the amount of supplied reactant gas and operation of decreasing the voltage of the fuel cell as a series of processes, and such operations do not necessarily need to be performed at the same time.).

Further, at the time of transition from the idling power generation suppression mode to the normal mode, the voltage of the fuel cell is decreased from the predetermined voltage value. If the predetermined voltage value is set to a value below the voltage range where an oxidation-reduction of platinum proceeds, at the time of transition from the idling power generation suppression mode to the normal mode, the voltage of the fuel cell does not pass through the voltage range where the oxidation-reduction proceeds. Thus, in this case, it becomes possible to prevent degradation of the fuel cell which may be caused if the voltage of the fuel cell passes through the voltage range where the oxidation-reduction proceeds.

At the time of transition from the idling power generation suppression mode to the normal mode, voltage change of the fuel cell may be suppressed. If the output voltage of the fuel cell is changed rapidly, degradation of the fuel cell may occur undesirably. In the above structure, since the rapid fluctuation of the output voltage can be suppressed, degradation of the fuel cell can be suppressed advantageously.

Before transition from the idling power generation suppression mode to the normal mode as a result of increase in the load, the back pressure valve may be moved in a closing direction. By moving the back pressure valve in the closing direction, the pressure of the air in the cathode channel of the fuel cell is increased, and oxygen concentration (volume concentration) per volume flow rate is increased. Thus, recovery from the idling state to the normal state can be performed rapidly.

A vehicle according to the present invention is equipped with the above described fuel cell system. Thus, high durability and high efficiency are achieved in the vehicle.

The above and other objects, features and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a diagram schematically showing an overall structure of a fuel cell vehicle equipped with a fuel cell system according to a first embodiment of the present invention;

FIG. 2 is a block diagram showing a power system of the fuel cell vehicle;

FIG. 3 is a diagram schematically showing a structure of a fuel cell unit according to the first embodiment;

FIG. 4 is a diagram showing details of a DC/DC converter according to the first embodiment;

FIG. 5 is a flow chart showing basic control in an electronic control unit (ECU);

FIG. 6 is a flow chart of calculating a system load;

FIG. 7 is a graph showing the relationship between the current rotation number of a motor and the estimated electric power consumed by the motor;

FIG. 8 is a graph showing the relationship among the SOC of a battery, the charging/discharging coefficient, and the average regenerative electric power;

FIG. 9 is a graph showing an example of the relationship between the electric potential of a fuel cell of a fuel cell stack and degradation of the fuel cell;

FIG. 10 is a cyclic voltammetry diagram showing an example of the progress of oxidation and the progress of reduction in the cases of different varying speeds in the electric potential of the fuel cell;

FIG. 11 is a graph showing a plurality of power supply modes in the first embodiment;

FIG. 12 is a flow chart where the ECU performs energy management of the fuel cell system in the first embodiment;

FIG. 13 is a graph showing the relationship between the cathode stoichiometric ratio and the cell current;

FIG. 14 is a flowchart of a second normal mode;

FIG. 15 is a graph showing the relationship between the target FC current and the target oxygen concentration;

FIG. 16 is a graph showing the relationship between the target oxygen concentration and target FC current, and the target air pump rotation number and the target water pump rotation number;

FIG. 17 is a graph showing the relationship between the target oxygen concentration and the target FC current, and the target opening degree of a back pressure valve;

FIG. 18 is a graph showing the relationship between the target FC current and the flow rate of air;

FIG. 19 is a graph showing the relationship between the opening degree of a circulation valve and the flow rate of a circulating gas;

FIG. 20 is a flow chart showing a second idling power generation suppression mode;

FIG. 21 is a flow chart showing torque control of the motor;

FIG. 22 is an example of time chart in the cases where various controls according to the first embodiment and a comparative example are used;

FIG. 23 is a flow chart where the ECU performs energy management of the fuel cell system in a second embodiment;

FIG. 24 is an example of a time chart in the case where various controls according to the second embodiment are used;

FIG. 25 is a block diagram schematically showing a structure of a first modified example of the fuel cell system according to the first embodiment;

FIG. 26 is a block diagram schematically showing a structure of a second modified example of the fuel cell system according to the first embodiment; and

FIG. 27 is a block diagram schematically showing a structure of a third modified example of the fuel cell system according to the first embodiment.

### DESCRIPTION OF THE PREFERRED EMBODIMENTS

### A. First Embodiment

### 1. Description Regarding Overall Structure

### [1-1. Overall Structure]

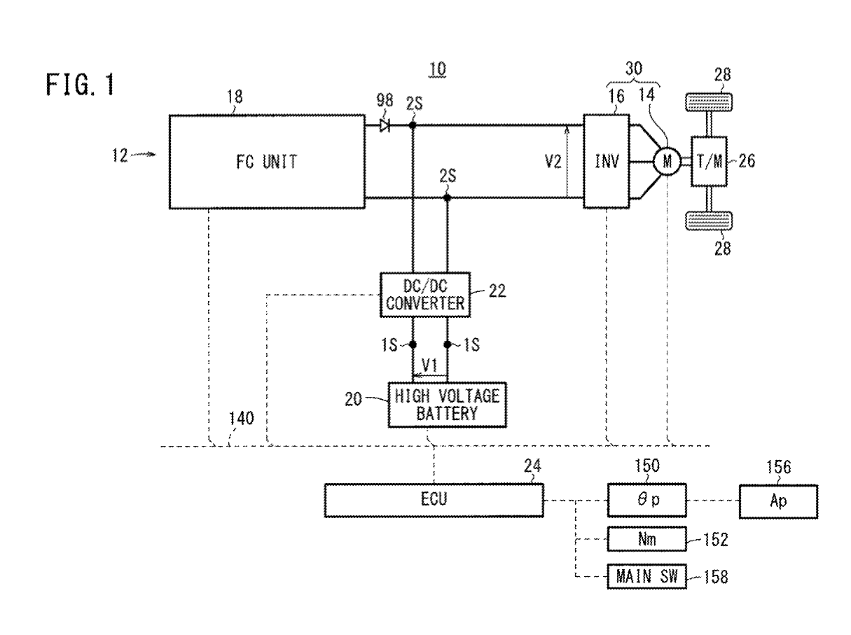

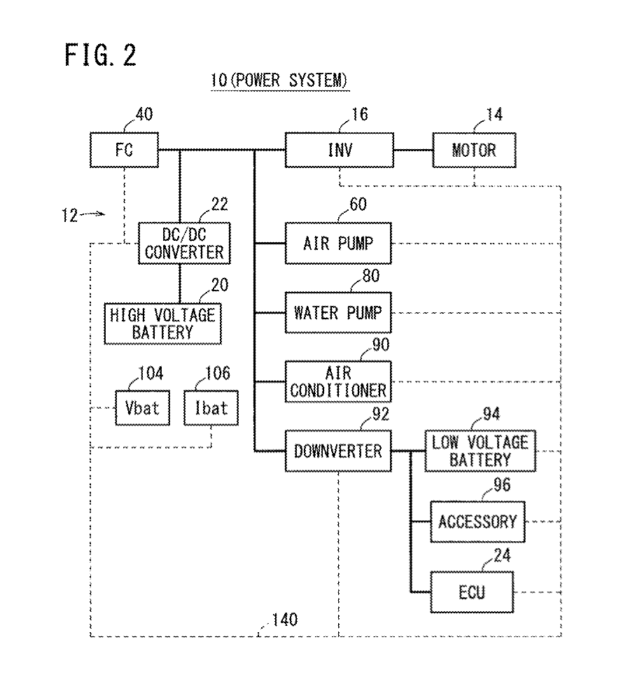

FIG. 1 is a diagram schematically showing the overall structure of a fuel cell vehicle 10 (hereinafter referred to as the “FC vehicle 10”) equipped with a fuel cell system 12 (hereinafter referred to as the “FC system 12”) according to a first embodiment of the present invention. FIG. 2 is a block diagram showing a power system of the FC vehicle 10. As shown in FIGS. 1 and 2, the FC vehicle 10 includes a traction motor 14 and an inverter (auxiliary device) 16 in addition to the FC system 12.

The FC system 12 includes a fuel cell unit 18 (hereinafter referred to as the “FC unit 18”), a high voltage battery (hereinafter referred to as the “battery 20”) (energy storage device), a DC/DC converter 22, and an electronic control unit (control device) 24 (hereinafter referred to as the “ECU 24”).

### [1-2. Drive System]

The motor 14 generates a driving force based on the electric power supplied from the FC unit 18 and the battery 20, and rotates wheels 28 using the driving force through a transmission 26. Further, the motor 14 outputs electric power generated by regeneration (regenerative electric power Preg) [W] to the battery 20 or the like (see FIG. 2).

The inverter 16 has three phase bridge structure, and carries out DC/AC conversion to convert direct current into alternating current in three phases. The inverter 16 supplies the alternating current to the motor 14, and supplies the direct current after AC/DC conversion as a result of regeneration to the battery 20 or the like through a DC/DC converter 22.

It should be noted that the motor 14 and the inverter 16 are collectively referred to as a load 30. The load 30 may include components (auxiliary device) such as an air pump (reactant gas supply apparatus) 60, a water pump 80, and an air conditioner 90 as described later.

### [1-3. FC System]

### (1-3-1. Overall Structure)

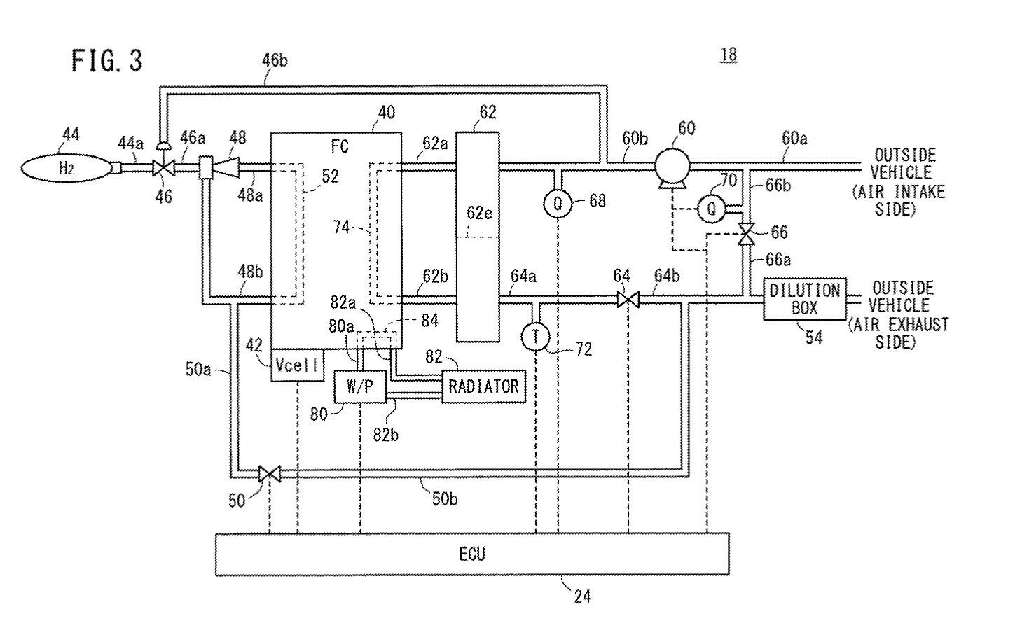

FIG. 3 is a diagram schematically showing a structure of the FC unit 18. The FC unit 18 includes a fuel cell stack 40 (hereinafter referred to as the “FC stack 40” or the “FC 40”), an anode system for supplying hydrogen (fuel gas) to, and discharging the hydrogen (fuel gas) from anodes of the FC stack 40, a cathode system for supplying the air (oxygen-containing gas) to, and discharging the air (oxygen-containing gas) from cathodes of the FC stack 40, a coolant system for circulating coolant water (coolant) to cool the FC stack 40, and a cell voltage monitor 42.

### (1-3-2. FC Stack 40)

For example, the FC stack 40 is formed by stacking fuel cells (hereinafter referred to as the “FC cells”) each including an anode, a cathode, and a solid polymer electrolyte membrane interposed between the anode and the cathode.

### (1-3-3. Anode System)

The anode system includes a hydrogen tank 44 (reactant gas supply apparatus), a regulator 46, an ejector 48, and a purge valve 50. The hydrogen tank 44 contains hydrogen as the fuel gas. The hydrogen tank 44 is connected to the inlet of an anode channel 52 through a pipe 44a, a regulator 46, a pipe 46a, an ejector 48, and a pipe 48a. Thus, the hydrogen in the hydrogen tank 44 can be supplied to the anode channel 52 through the pipe 44a or the like. A shut-off valve (not shown) is provided in the pipe 44a. At the time of power generation of the FC stack 40, the shut-off valve is opened by the ECU 24.

The regulator 46 regulates the pressure of the supplied hydrogen to a predetermined value, and discharges the hydrogen. That is, the regulator 46 regulates the pressure on the downstream side (pressure of the hydrogen on the anode side) in response to the pressure (pilot pressure) of the air on the cathode side supplied through a pipe 46b. Therefore, the pressure of the hydrogen on the anode side is linked to the pressure of the air on the cathode side. As described later, by changing the rotation number or the like of the air pump 60 so as to change the oxygen concentration, the pressure of the hydrogen on the anode side changes as well.

The ejector 48 generates a negative pressure by ejecting hydrogen from the hydrogen tank 44 through a nozzle. By this negative pressure, the anode off gas can be sucked from a pipe 48b.

The outlet of the anode channel 52 is connected to a suction port of the ejector 48 through the pipe 48b. The anode off gas discharged from the anode channel 52 flows through the pipe 48b and again into the ejector 48 to allow circulation of the anode off gas (hydrogen).

The anode off gas contains hydrogen that has not been consumed in the electrode reaction at the anodes, and water vapor. Further, a gas-liquid separator (not shown) is provided at the pipe 48b for separating/recovering water components (condensed water (liquid) and water vapor (gas)) in the anode off gas.

Part of the pipe 48b is connected to a dilution box 54 provided in a pipe 64b as described later, through a pipe 50a, a purge valve 50, and a pipe 50b. When it is determined that power generation of the FC stack 40 is not performed stably, the purge valve 50 is opened for a predetermined period in accordance with an instruction from the ECU 24. In the dilution box 54, the hydrogen in the anode off gas from the purge valve 50 is diluted by the cathode off gas.

### (1-3-4. Cathode System)

The cathode system includes the air pump 60, a humidifier 62, a back pressure valve (reactant gas supply apparatus) 64, a circulation valve (reactant gas supply apparatus) 66, flow rate sensors 68, 70, and a temperature sensor 72.

The air pump 60 compresses the external air (air), and supplies the compressed air to the cathode. A suction port of the air pump 60 is connected to the outside (outside of the vehicle) through a pipe 60a, and an ejection port of the air pump 60 is connected to the inlet of a cathode channel 74 through a pipe 60b, the humidifier 62, and a pipe 62a. When the air pump 60 is operated in accordance with an instruction from the ECU 24, the air pump 60 sucks the air outside the vehicle through the pipe 60a, compresses the sucked air, and supplies the compressed air to the cathode channel 74 through the pipe 60b or the like under pressure.

The humidifier 62 has a plurality of hollow fiber membranes 62e having water permeability. The humidifier 62 humidifies the air flowing toward the cathode channel 74 through the hollow fiber membranes 62e by exchanging water components between the air flowing toward the cathode channel 74 and the highly humidified cathode off gas discharged from the cathode channel 74.

A pipe 62b, the humidifier 62, a pipe 64a, the back pressure valve 64, and the pipe 64b are provided at the outlet of the cathode channel 74. The cathode off gas (oxygen-containing off gas) discharged from the cathode channel 74 is discharged to the outside of the vehicle through the pipe 62b or the like. The dilution box 54 is provided at the pipe 64b.

For example, the back pressure valve 64 is a butterfly valve, and the opening degree of the back pressure valve 64 is controlled by the ECU 24 to regulate the pressure of the air in the cathode channel 74. More specifically, if the opening degree of the back pressure valve 64 becomes small, the pressure of the air in the cathode channel 74 is increased, and oxygen concentration per volume flow rate (volume concentration) becomes high. Conversely, if the opening degree of the back pressure valve 64 becomes large, the pressure of the air in the cathode channel 74 is decreased, and oxygen concentration per volume flow rate (volume concentration) becomes low.

The pipe 64b is connected to the pipe 60a through a pipe 66a, the circulation valve 66, and a pipe 66b. Thus, some of the exhaust gas (cathode off gas) is supplied as a circulating gas to the pipe 60a through the pipe 66a, the circulation valve 66, and the pipe 66b. The circulating gas is mixed with the fresh air from the outside of the vehicle, and sucked into the air pump 60.

For example, the circulation valve 66 is a butterfly valve, and the opening degree of the circulation valve 66 is controlled by the ECU 24 to regulate the flow rate of the circulating gas.

A flow rate sensor 68 is connected to the pipe 60b. The flow rate sensor 68 detects the flow rate [g/s] of the air flowing toward the cathode channel 74, and outputs the detected flow rate to the ECU 24. A flow rate sensor 70 is connected to the pipe 66b. The flow rate sensor 70 detects the flow rate QC [g/s] of the circulating gas flowing toward the pipe 60a, and outputs the detected flow rate to the ECU 24.

A temperature sensor 72 is connected to the pipe 64a. The temperature sensor 72 detects the temperature of the cathode off gas, and the temperature sensor 72 outputs the detected temperature to the ECU 24. Since the temperature of the circulating gas is substantially equal to the temperature of the cathode off gas, the temperature of the circulating gas can be detected based on the temperature of the cathode off gas detected by the temperature sensor 72.

### (1-3-5. Cooling System)

The cooling system includes a water pump 80 and a radiator (heat radiator) 82. The water pump 80 circulates the coolant water (coolant), and an ejection port of the water pump 80 is connected to a suction port of the water pump 80 through a pipe 80a, a coolant channel 84, a pipe 82a, the radiator 82 and a pipe 82b in the order listed. When the water pump 80 is operated in accordance with an instruction from the ECU 24, the coolant water is circulated between the coolant channel 84 and the radiator 82 to cool the FC stack 40.

### (1-3-6. Cell Voltage Monitor)

The cell voltage monitor 42 is a device for detecting the cell voltage Vcell of each of unit cells of the FC stack 40. The cell voltage monitor 42 includes a monitor body, and a wire harness connecting the monitor body with each of the unit cells. The monitor body scans all of the unit cells at predetermined intervals to detect the cell voltage Vcell of each cell, and calculates the average cell voltage and the lowest cell voltage. Then, the monitor body outputs the average cell voltage and the lowest cell voltage to the ECU 24.

### (1-3-7. Power System)

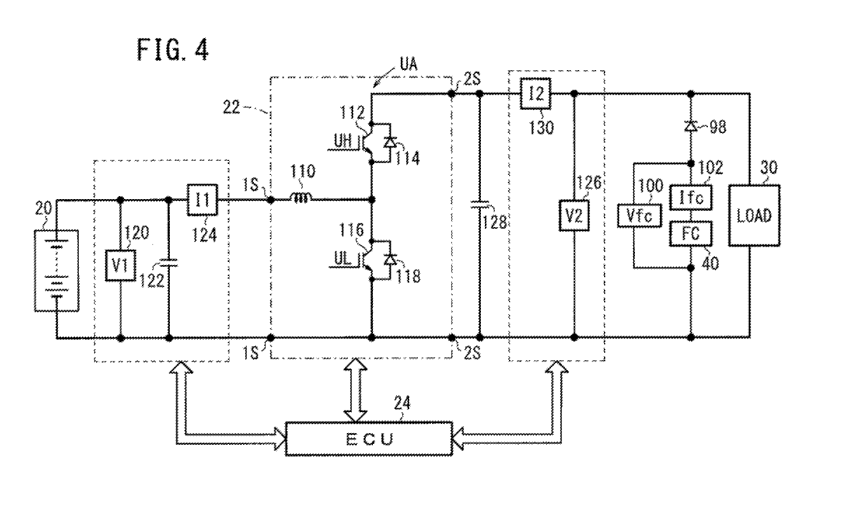

As shown in FIG. 2, electric power from the FC 40 (hereinafter referred to as the “FC electric power Pfc”) is supplied to the air pump 60, the water pump 80, the air conditioner 90, a downverter 92 (voltage step down DC/DC converter), a low voltage battery 94, an accessory 96, and the ECU 24 in addition to the inverter 16 and the motor 14 (during power running), the DC/DC converter 22, and the high voltage battery 20 (during charging). As shown in FIG. 1, a back flow prevention diode 98 is disposed between the FC unit 18 (FC 40) and the inverter 16 and the DC/DC converter 22. Further, the power generation voltage of the FC 40 (hereinafter referred to as the “FC voltage Vfc”) is detected by a voltage sensor 100 (FIG. 4), and the power generation current of the FC 40 (hereinafter referred to as the FC current Ifc″) is detected by a current sensor 102. The FC voltage Vfc and the FC current Ifc are outputted to the ECU 24.

### [1-4. High Voltage Battery 20]

The battery 20 is an energy storage device (energy storage) containing a plurality of battery cells. For example, a lithium-ion secondary battery, a nickel hydrogen secondary battery, or a capacitor can be used as the battery 20. In the first embodiment, the lithium-ion secondary battery is used. The output voltage [V] of the battery 20 (hereinafter referred to as the “battery voltage Vbat”) is detected by a voltage sensor 104 (FIG. 2), and the output current [A] of the battery 20 (hereinafter referred to as the “battery current Ibat”) is detected by the current sensor 106. The battery voltage Vbat and the battery current Ibat are outputted to the ECU 24. The ECU 24 calculates the remaining battery level (state of charge) (hereinafter referred to as the “SOC”) [%] of the battery 20 based on the battery voltage Vbat and the battery current Ibat.

### [1-5. DC/DC Converter 22]

The DC/DC converter 22 controls targets to which the FC electric power Pfc from the FC unit 18, the electric power [W] supplied from the battery 20 (hereinafter referred to as the “battery electric power Pbat”), and the regenerative electric power Preg from the motor 14 are supplied.

FIG. 4 shows details of the DC/DC converter 22 in the first embodiment. As shown in FIG. 4, one side of the DC/DC converter 22 is connected to the primary side 1S where the battery 20 is provided, and the other side of the DC/DC converter 22 is connected to the secondary side 2S, which is connection points between the load 30 and the FC 40.

The DC/DC converter 22 is a chopper type step up/down voltage converter for increasing the voltage on the primary side 1S (primary voltage V1) [V] to the voltage on the secondary side 2S (secondary voltage V2) [V] (V1≦V2), and decreasing the secondary voltage V2 to the primary voltage V1.

As shown in FIG. 4, the DC/DC converter 22 includes a phase arm UA interposed between the primary side is and the secondary side 2S, and a reactor 110.

The phase arm UA includes an upper arm element (an upper switching element 112 and a diode 114) and a lower arm element (a lower arm switching element 116 and a diode 118). For example, MOSFET, IGBT, or the like is adopted in each of the upper arm switching element 112 and the lower arm switching element 116.

The reactor 110 is interposed between the middle point (common connection point) of the phase arm UA and the positive electrode of the battery 20. The reactor 110 is operated to release and accumulate energy during voltage conversion between the primary voltage V1 and the secondary voltage V2 by the DC/DC converter 22.

The upper arm switching element 112 is turned on when high level of a gate drive signal (drive voltage) UH is outputted from the ECU 24, and the lower arm switching element 116 is turned on when high level of a gate drive signal (drive voltage) UL is outputted from the ECU 24.

The ECU 24 detects primary voltage Vi by a voltage sensor 120 provided in parallel with a smoothing capacitor 122 on the primary side, and detects electrical current on the primary side (primary current I1) [A] by a current sensor 124. Further, the ECU 24 detects secondary voltage V2 by a voltage sensor 126 provided in parallel with the smoothing capacitor 128 on the secondary side, and detects electrical current on the secondary side (secondary current 12) [A] by a current sensor 130.

### [1-6. ECU 24]

The ECU 24 controls the motor 14, the inverter 16, the FC unit 18, the battery 20, and the DC/DC converter 22 through a communication line 140 (see e.g., FIG. 1). For implementing the control, programs stored in a memory (ROM) are executed, and detection values obtained by various sensors such as the cell voltage monitor 42, the flow rate sensors 68, 70, the temperature sensor 72, the voltage sensors 100, 104, 120, 126, and the current sensors 102, 106, 124, 130 are used.

In addition to the above sensors, the various sensors herein include an opening degree sensor 150 and a motor rotation number sensor 152 (FIG. 1). The opening degree sensor 150 detects the opening degree θp [degrees] of an accelerator pedal 156, and the rotation number sensor 152 detects the rotation number Nm [rpm] of the motor 14. The ECU 24 detects the vehicle velocity V [km/h] of the FC vehicle 10 based on the rotation number Nm. Further, a main switch 158 (hereinafter referred to as the “main SW 158”) is connected to the ECU 24. The main SW 158 switches between supply and non-supply of the electric power from the FC unit 18 and the battery 20 to the motor 14. This main SW 158 can be operated by a user.

The ECU 24 includes a microcomputer. Further, as necessary, the ECU 24 has a timer and input/output (I/O) interfaces such as an A/D converter and a D/A converter. The ECU 24 may comprise only a single ECU. Alternatively, the ECU 24 may comprise a plurality of ECUs for each of the motor 14, the FC unit 18, the battery 20, and the DC/DC converter 22.

After the load required by the FC system 12, i.e., required by the FC vehicle 10 as a whole is determined based on the state of the FC stack 40, the state of the battery 20, and the state of the motor 14, and also based on inputs (load requests) from various switches and various sensors, the ECU 24 determines allocation (shares) of loads through adjustment, and more specifically determines a good balance among a load which should be assigned to the FC stack 40, a load which should be assigned to the battery 20, and a load which should be assigned to the regenerative power supply (motor 14), and sends instructions to the motor 14, the inverter 16, the FC unit 18, the battery 20, and the DC/DC converter 22.

### 2. Control According to First Embodiment

Next, control in the ECU 24 will be described.

### [2-1. Basic Control]

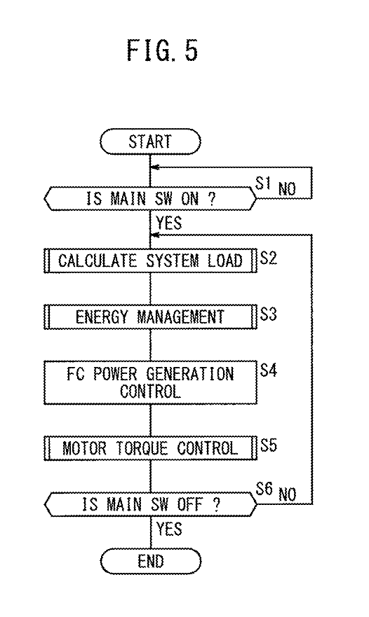

FIG. 5 is a flow chart showing basic control in the ECU 24. In step S1, the ECU 24 determines whether or not the main SW 158 is in an ON state. If the main SW 158 is not in the ON state (S1: NO), step S1 is repeated. If the main SW 158 is in the ON state (S1: YES), the control proceeds to step S2. In step S2, the ECU 24 calculates the load (system load Psys) [W] required by the FC system 12.

In step S3, the ECU 24 performs energy management of the FC system 12. The energy management herein is intended to suppress degradation of the FC stack 40, and improve the efficiency in the output of the entire FC system 12.

In step S4, the ECU 24 implements control for peripheral devices of the FC stack 40, i.e., the air pump 60, the back pressure valve 64, the circulation valve 66, and the water pump 80 (FC power generation control). In step S5, the ECU 24 implements torque control of the motor 14.

In step S6, the ECU 24 determines whether or not the main SW 158 is in an OFF state. If the main SW 158 is not in the OFF state (S6: NO), the control returns to step S2. If the main SW 158 is in the ON state (S6: YES), the current process is finished.

### [2-2. Calculation of System Load Psys]

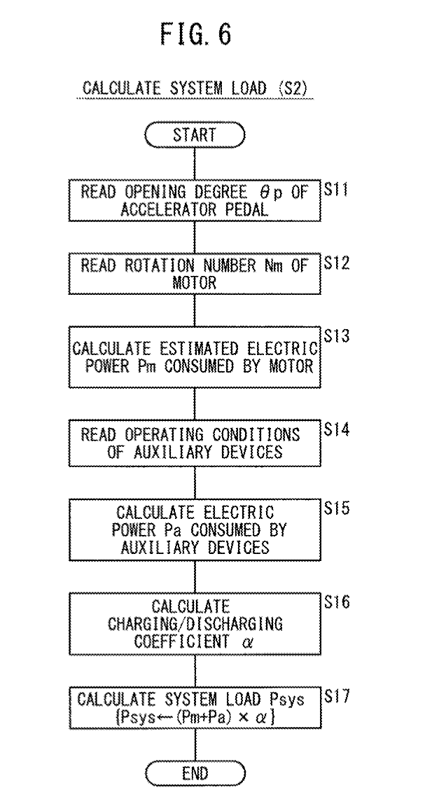

FIG. 6 is a flow chart for calculating the system load Psys. In step S11, the ECU 24 reads the opening degree θp of the accelerator pedal 156 from the opening degree sensor 150. In step S12, the ECU 24 reads the rotation number Nm [rpm] of the motor 14 from the rotation number sensor 152.

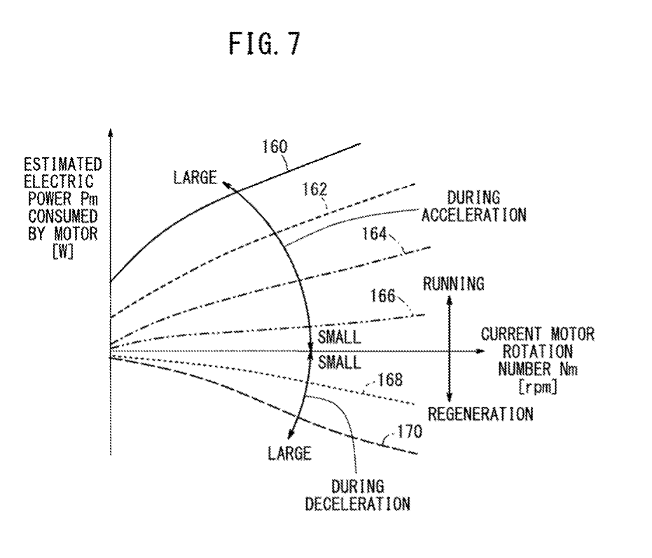

In step S13, the ECU 24 calculates the estimated electric power Pm [W] consumed by the motor 14 based on the opening degree θp and the rotation number Nm. Specifically, in a map shown in FIG. 7, the relationship between the rotation number Nm and the estimated consumed energy Pm is stored for each opening degree θp. For example, in the case where the opening degree θp is θp1, a characteristic 160 is used. Likewise, in the cases where the opening degrees θp are θp2, θp3, θp4, θp5, and θp6, characteristics 162, 164, 166, 168, and 170 are used, respectively. After the characteristic indicating the relationship between the rotation number Nm and the consumed electric power Pm is determined based on the opening degree θp, based on the determined characteristic, the estimated consumed energy Pm in correspondence with the rotation number Nm is determined.

In step S14, the ECU 24 reads data of the current operating conditions from auxiliary devices. For example, the auxiliary devices herein include auxiliary devices operated at high voltage, such as the air pump 60, the water pump 80, and the air conditioner 90, and auxiliary devices operated at low voltage, such as the low voltage battery 94, the accessory 96, and the ECU 24. For example, as for the operating condition of the air pump 60, the rotation number of the air pump 60 (hereinafter referred as the “air pump rotation number Nap” or the “rotation number Nap”) [rpm] is read. As for the operating condition of the water pump 80, the rotation number of the water pump 80 (hereinafter referred to as the “water pump rotation number Nwp” or the “rotation number Nwp”) [rpm] is read. As for the operating condition of the air conditioner 90, output settings of the air conditioner 90 are read.

In step 515, the ECU 24 calculates the electric power Pa [W] consumed by the auxiliary devices depending on the present operating conditions of the auxiliary devices. In step S16, the ECU 24 calculates charging/discharging coefficient α. The charging/discharging coefficient α is a coefficient by which the sum (provisional system load) of the estimated electric power Pm consumed by the motor 14 and electric power Pa consumed by the auxiliary devices is multiplied. The charging/discharging coefficient α is determined depending on the SOC of the battery 20 and an average value of the regenerative electric power Preg of the motor 14 (hereinafter referred to as the “average regenerative electric power Pregave”). The average regenerative electric power Pregave is an average value of the regenerative electric power Preg obtained within a predetermined period.

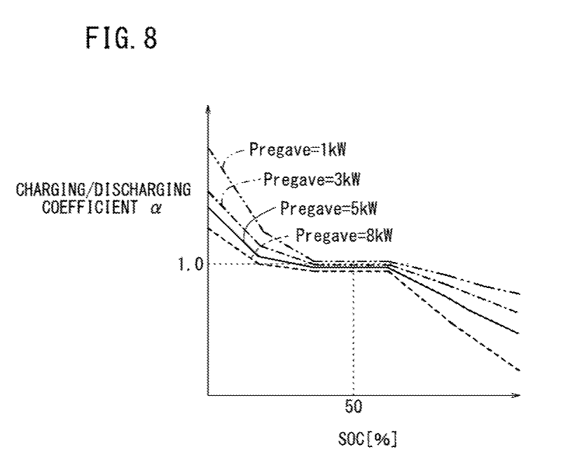

FIG. 8 is map showing the relationship among the SOC, the charging/discharging coefficient α, and the average regenerative electric power Pregave. In an example of FIG. 8, the target SOC is 50%. When the SOC exceeds 50%, (when the battery 20 is in a sufficiently charged state), the charging/discharging coefficient α is set to be less than 1. Thus, by multiplying the provisional system load by a multiplier factor less than 1, the system load Psys is made small, and then it becomes possible to consume the excessive electric power of the battery 20. Further, when the SOC is less than 50% (when charging is required), the charging/discharging coefficient α is set to be greater than 1. Thus, by multiplying the provisional system load by a multiplier factor greater than 1, the system load Psys is made large, and then it becomes possible to compensate for the shortage of SOC. As shown in FIG. 8, in a range around 50% of the SOC, a dead zone where the charging/discharging coefficient α is 1 is provided.

Further, in the example of FIG. 8, the relationship between the SOC and the charging/discharging coefficient α is switched depending on the average regenerative electric power Pregave. That is, as shown in FIG. 8, if the average regenerative electric power Pregave is low (i.e., in an environment where it is difficult to obtain the regenerative electric power Preg), since it is likely that the regenerative electric power Preg is not sufficient, in a range where the SOC exceeds 50%, the charging/discharging coefficient α is increased relatively, and in a range where the SOC is less than 50%, the charging/discharging coefficient α is changed to a value which is remote from 1. If the average regenerative electric power Pregave is high (i.e., in an environment where it is easy to obtain the regenerative electric power Preg), since it is likely that the larger regenerative electric power Preg is available, in a range where the SOC exceeds 50%, the charging/discharging coefficient α is decreased relatively, and in a range where the SOC is less than 50%, the charging/discharging coefficient α is changed to a value which is close to 1. The target SOC may be set to a value other than 50%. Further, measured values or simulated values can be used in the map of FIG. 8.

Referring back to FIG. 6, in step 517, the ECU 24 multiplies the sum (provisional system load) of the estimated electric power Pm consumed by the motor 14 and the electric power Pa consumed by the auxiliary devices by the charging/discharging coefficient α to calculate the estimated consumed electric power in the entire FC vehicle 10 (i.e., system load Psys).

### [2-3. Energy Management]

As described above, the energy management in the first embodiment is aimed to improve the efficiency in the output of the entire FC system 12, while suppressing degradation of the FC stack 40.

### (2-3-1. Premise)

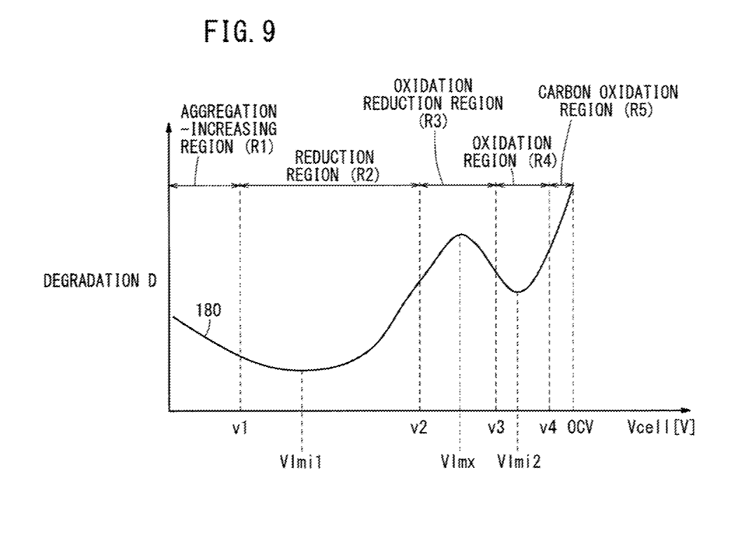

FIG. 9 shows an example of the relationship between the voltage of the FC cell of the FC stack 40 (cell voltage Vcell) [V] and the degradation D of the cell. That is, a curve 180 in FIG. 9 shows the relationship between the cell voltage Vcell and the degradation D.

In FIG. 9, in a region below the electric potential v1 (e.g., 0.5V), reduction reaction of platinum (oxidized platinum) in the FC cell proceeds heavily, and aggregation of platinum occurs excessively (hereinafter referred to as the “platinum-aggregation increasing region R1” or the “aggregation increasing region R1”). In a region from the electric potential v1 to the electric potential v2 (e.g., 0.8V), reduction reaction proceeds stably (hereinafter referred to as the “platinum reduction region R2” or the “reduction region R2”).

In a region from the electric potential v2 to the electric potential v3 (e.g. 0.9V), oxidation-reduction reaction of platinum proceeds (hereinafter referred to as the “platinum oxidation reduction progress region R3” or the “oxidation reduction region R3”). In a region from the electric potential v3 to the electric potential v4 (e.g., 0.95V), oxidation reaction of platinum proceeds stably (hereinafter referred to as the stable platinum oxidation region R4″ or the “oxidation region R4”). In a region from the electric potential v4 to OCV (open circuit voltage), oxidation of carbon in the cell proceeds (hereinafter referred to as the “carbon oxidation region R5”).

As described above, in FIG. 9, if the cell voltage Vcell is in the platinum reduction region R2 or the stable platinum oxidation region R4, degradation of the FC cell occurs to a smaller extent in comparison with the adjacent regions. In contrast, if the cell voltage Vcell is in the platinum-aggregation increasing region R1, the platinum oxidation reduction progress region R3, or the carbon oxidation region R5, degradation of the FC cell occurs to a greater extent in comparison with the adjacent regions.

In FIG. 9, on the face of it, a curve 180 is uniquely determined. However, in practice, the curve 180 varies depending on variation of the cell voltage Vcell (varying speed Acell) [V/sec] per unit time.

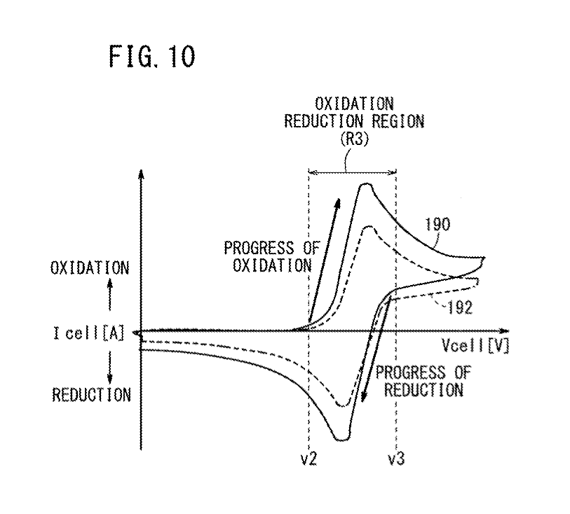

FIG. 10 is a cyclic voltammetry diagram showing an example of the progress of oxidation and the progress of reduction in the cases of different varying speeds Acell. In FIG. 10, a curve 190 shows a case where the varying speed Acell is high, and a curve 192 shows a case where the varying speed Acell is low. As can be seen from FIG. 10, since the degree of the progress in oxidation and reduction varies depending on the varying speed Acell, the electric potentials v1 to v4 cannot necessarily be determined uniquely. Further, the electric potentials v1 to v4 may change depending on the individual difference in the FC cell. Therefore, preferably, the electric potentials v1 to v4 should be set at the theoretical values, simulation values, or the measured values with the errors being taken into account.

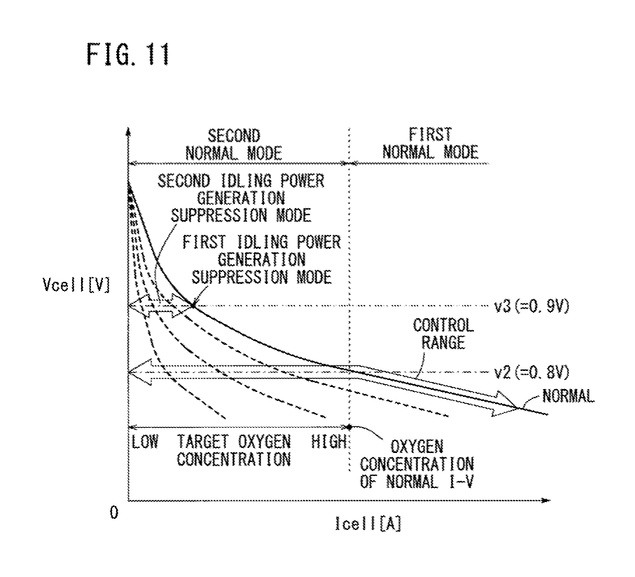

Further, in the current-voltage (IV) characteristic of the FC cell, as in the case of normal fuel cells, as the cell voltage Vcell decreases, the cell current Icell [A] is increased (see FIG. 11). Additionally, the power generation voltage (FC voltage Vfc) of the FC stack 40 is obtained by multiplying the cell voltage Vcell by the serial connection number Nfc in the FC stack 40. The serial connection number Nfc indicates the number of FC cells connected in series in the FC stack 40. The serial connection number Nfc is also simply referred to as the “cell number”.

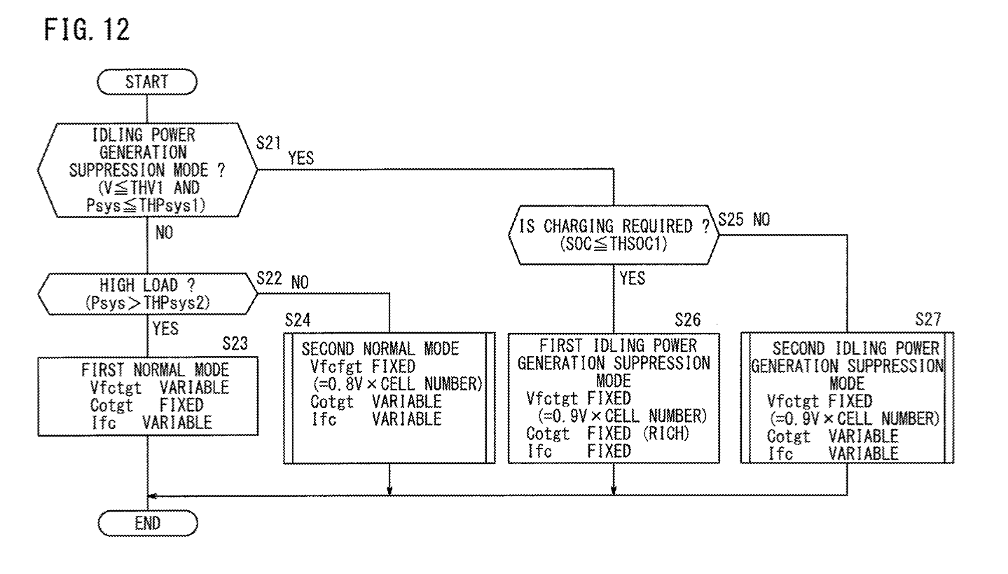

In view of the above, in the first embodiment, during voltage conversion operation of the DC/DC converter 22, the target voltage (target FC voltage Vfctgt) of the FC stack 40 is mainly set within the platinum reduction region R2, and as necessary, set within the stable platinum oxidation region R4 (Specific examples will be described with reference to, e.g., FIG. 12.). By switching the target FC voltage Vfctgt in this manner, the time where the FC voltage Vfc is in the regions R1, R3, and R5 (in particular, platinum oxidation reduction progress region R3) can be reduced as much as possible, whereby degradation of the FC stack 40 can be prevented.

In the above process, the electric power supplied by the FC stack 40 (FC electric power Pfc) may not be equal to the system load Psys. In this regard, if the FC electric power Pfc is less than the system load Psys, electric power for the shortage is supplied from the battery 20. Further, if the FC electric power Pfc exceeds the system load Psys, the battery 20 is charged with the excessive electric power of the FC electric power Pfc.

In FIG. 9, the electric potentials v1 to v4 are specified as specific numeric values for implementing control as described later. The numeric values are merely determined for convenience in the control. Stated otherwise, as can be seen from the curve 180, since degradation D changes continuously, the electric potentials v1 to v4 can be determined suitably depending on the specification of control.

The platinum reduction region R2 includes a minimal value of the curve 180 (first minimal value Vlmi1). The platinum oxidation reduction progress region R3 includes a maximal value of the curve 180 (maximal value Vlmx). The stable platinum oxidation region R4 includes another minimal value (second minimal value Vlmi2) of the curve 180.

(2-3-2. Power Supply Modes used in Energy Management)

FIG. 11 is a graph showing a plurality of power supply modes in the first embodiment. In the first embodiment, four control methods (power control modes) are used for controlling power supply (supply of electric power) in energy management. That is, in the first embodiment, switching is performed among a first normal mode and a second normal mode used in normal traveling (traveling in modes other than idling power generation suppression modes) and a first idling power generation suppression mode and a second idling power generation suppression mode used as the idling power generation suppression modes of the FC 40. In the idling power generation suppression modes, when the main switch 158 (FIG. 1) is the ON state, active power generation in the FC 40 is stopped. The active power generation herein means power generation of the FC 40 based on instructions from the ECU 24, and does not include power generation consuming the residual gas. For example, in the idling power generation suppression modes, the power generation is performed at a level below the lower limit power generation amount during normal power generation (lower limit value of the control range of the power generation amount) or power generation is stopped.

The first normal mode is mainly used when the system load Psys is relatively high. In the state where the target oxygen-concentration Cotgt is fixed (or oxygen is kept in a rich state), the target FC voltage Vfctgt is adjusted to control the FC current Ifc. In this manner, basically, the system load Psys can be covered with the FC electric power Pfc.

The second normal mode is mainly used when the system load Psys is relatively low. The target cell voltage Vcelltgt (=target FC voltage Vfctgt/cell number) is fixed to a reference electric potential (in the first embodiment, the electric potential v2 (=0.8 v)) which is equal to or less than an electric potential below the oxidation reduction region R3, and the target oxygen concentration Cotgt is variable, whereby FC electric current Ifc is made variable. In this manner, basically, it becomes possible to cover the system load Psys with the FC electric power Pfc (as described later in detail). The shortage of the FC electric power Pfc is supplemented with assistance of the battery 20.

The first idling power generation suppression mode is mainly used in the case where battery charging is required in the idling power generation suppression mode. The target cell voltage Vcelltgt (=target FC voltage Vfctgt/cell number) is fixed to an electric potential (in the first embodiment, the electric potential v3 (=0.9 v)) which is the electric potential of the oxidation reduction region R3 or more, and the FC electrical current Ifc is kept constant. The shortage of the FC electric power Pfc is supplemented with assistance of the battery 20, and excessive electric power of the FC electric power Pfc is used for charging the battery 20.

The second idling power generation suppression mode is mainly used in the case where charging of the battery 20 is not required in the idling power generation suppression mode. The target cell voltage Vcelltgt (=target FC voltage Vfctgt/cell number) is fixed to an electric potential (in the first embodiment, the electric potential v3 (=0.9 v)) which is the electric potential of the oxidation reduction region R3 or more, and the target oxygen concentration Cotgt is variable, whereby the FC electrical current Ifc is made variable. Thus, basically, the FC electric power Pfc can be changed in accordance with the system load Psys (details thereof will be described later). The shortage of the FC electric power Pfc is supplemented with assistance of the battery 20, and excessive electric power of the FC electric power Pfc is used for charging the battery 20.

### (2-3-3. Overflow of Energy Management)

FIG. 12 is a flow chart where the ECU 24 performs energy management (S3 of FIG. 5) of the FC system 12 in the first embodiment. In step S21, the ECU 24 determines whether or not the idling power generation suppression mode should be selected. More specifically, as a condition of the idling power generation suppression mode, the ECU 24 determines whether or not the vehicle velocity V is equal to or less than a threshold value THV1 and the system load Psys is equal to or less than a threshold value THPsys1.

The threshold value THV1 is a threshold value used for determining whether or not it is required to enter the idling power generation suppression mode (for example, a certain value in the range of 0<THV1≦20 km/s). The threshold value THPsys1 is a threshold value used for determining whether or not the system load Psys is small enough to select the idling power generation suppression mode. If the vehicle velocity V is more than the threshold value THV1 or if the system load Psys is more than the threshold value THPsys1 (S21: NO), the process proceeds to step S22.

In step S22, the ECU 24 determines whether or not the system load Psys exceeds a threshold value THPsys2 for determining whether or not the system load Psys is high. If the system load Psys exceeds the threshold value THPsys 2 (S22: YES), in step S23, the ECU 24 performs the first normal mode (implements voltage variable/current variable control). In step S22, in the case where the system load Psys is equal to or less than the threshold value THPsys2, (S22: NO), in step S24, the ECU 24 performs the second normal mode (implements voltage fixed/current variable control).

In step S21, in the case where the vehicle velocity V is equal to or less than the threshold value THV1 and the system load Psys is equal to or less than the threshold value THPsys1 (S21: YES), in step S25, the ECU 24 determines whether or not the SOC of the battery 20 is equal to or less than the threshold value THSOC1 for determining whether or not charging of the battery 20 is required. If the SOC is equal to or less than the threshold value THSOC1 (S25: YES), in step S26, the ECU 24 selects the first idling power generation suppression mode (voltage fixed/current fixed control). If the SOC is more than the threshold value THSOC1 (S25: NO), in step S27, the ECU 24 performs the second idling power generation suppression mode (voltage fixed/current variable control).

### (2-3-4. First Normal Mode)

As described above, the first normal mode is mainly used when the system load Psys is relatively high. In the state where the target oxygen concentration Cotgt is fixed (or oxygen is kept in a rich state), the target FC voltage Vfctgt is adjusted to control the FC current Ifc.

That is, as shown in FIG. 11, in the first normal mode, a normal current-voltage characteristic of a FC 40 (I-V characteristic indicated by a solid line in FIG. 11) is used. As in the case of the normal fuel cell, in the I-V characteristic of the FC 40, as the cell voltage Vcell (FC voltage Vfc) decreases, the cell current Icell (FC current Ifc) is increased. Thus, in the first normal mode, the target FC current Ifctgt is calculated depending on the system load Psys, and the target FC voltage Vfctgt is calculated in correspondence with the target FC current Ifctgt. The ECU 24 controls the DC/DC converter 22 such that the FC voltage Vfc is adjusted to the target FC voltage Vfctgt. That is, the primary voltage V1 is elevated by the DC/DC converter 22 such that the secondary voltage V2 is adjusted to the target FC voltage Vfctgt, whereby the FC voltage Vfc is controlled and the FC current Ifc is controlled. The second normal mode, the first idling power generation suppression mode, and the second idling power generation suppression mode are the same in that the primary voltage V1 is elevated by the DC/DC converter 22 such that the secondary voltage V2 is adjusted to the target FC voltage Vfctgt.

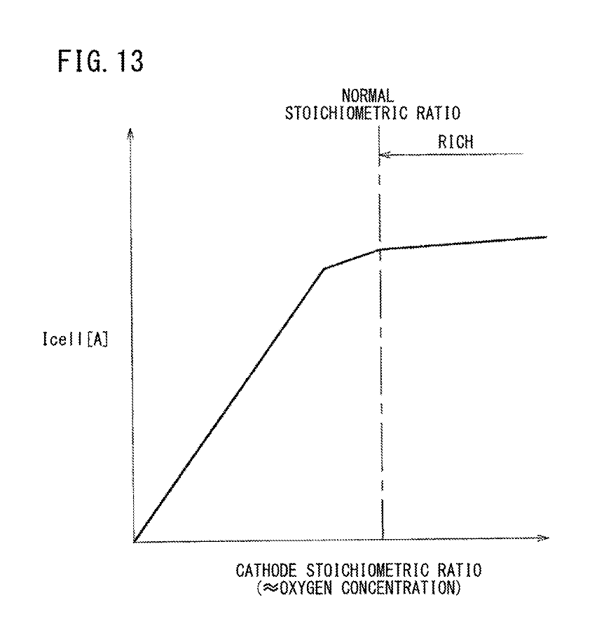

The expression “oxygen is in a rich state” means that oxygen is in a state where, for example, as shown in FIG. 13, the cell current Icell is kept at a constant level even if the cathode stoichiometric ratio is increased. In this state, oxygen is present at the normal stoichiometric ratio or more where oxygen is substantially saturated. The meaning of the expression “hydrogen is in a rich state” can be understood in the same manner. The cathode stoichiometric ratio herein means the flow rate of the air supplied to the cathode channel 74/the flow rate of the air consumed by power generation in the FC 40, and it is closely related to oxygen concentration in the cathode channel 74. The cathode stoichiometric ratio is adjusted, e.g., by controlling oxygen concentration.

In the first normal mode as described above, even if the system load Psys is high, basically, the entire system load Psys can be covered with the FC electric power Pfc.

### (2-3-5. Second Normal Mode)

As described above, the second normal mode is mainly used when the system load Psys is relatively low. The target cell voltage Vcelltgt (=target FC voltage Vfctgt/cell number) is fixed to a reference electric potential (in the first embodiment, the electric potential v2 (=0.8 v)) which is equal to or less than an electric potential below the oxidation reduction region R3, and the target oxygen concentration Cotgt is variable. Thus, the FC current is variable.

That is, as shown in FIG. 11, in the second normal mode, while the cell voltage Vcell is kept at a constant level, the oxygen concentration Co is decreased by decreasing the target oxygen concentration Cotgt. As shown in FIG. 13, when the cathode stoichiometric ratio (oxygen concentration Co) is decreased, the cell current Icell (FC current Ifc) is accordingly decreased. Therefore, in the state where the cell voltage Vcell is kept at a constant level, by increasing or decreasing the target oxygen concentration Cotgt, it becomes possible to control the cell current Icell (FC current Ifc) and the FC electric power Pfc. The shortage of the FC electric power Pfc is supplemented with assistance of the battery 20.

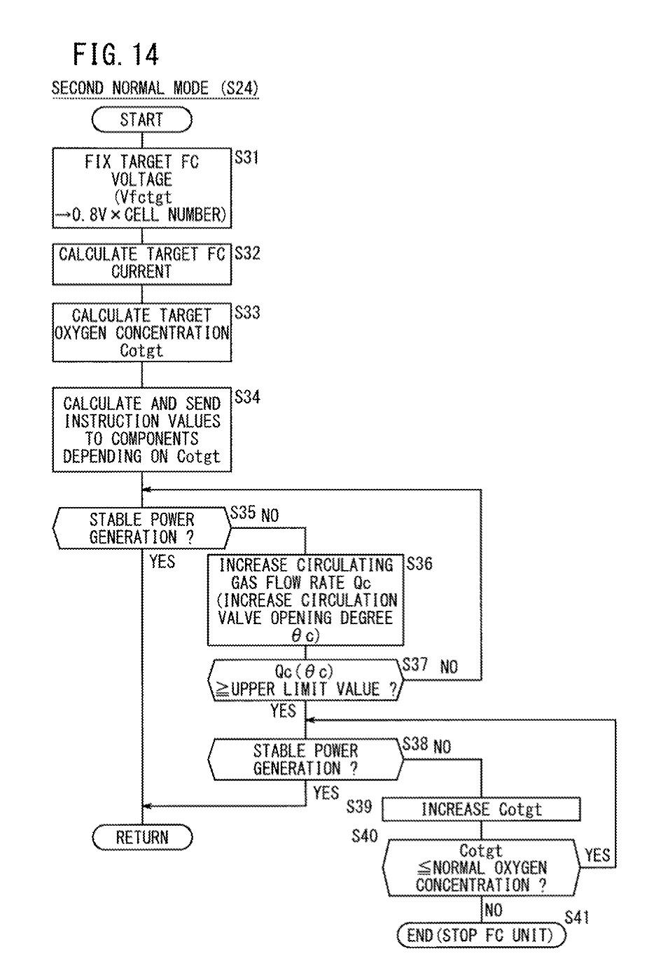

FIG. 14 is a flow chart showing the second normal mode. In step S31, the ECU 24 fixes the target FC voltage Vfctgt to a reference electric potential (in the first embodiment, the electric potential v2 (=0.8 v))×cell number by adjusting the voltage elevating rate of the DC/DC converter 22, the reference electric potential being set to be equal to or less than an electric potential below the oxidation reduction region R3. In step S32, the ECU 24 calculates the target FC current Ifctgt in correspondence with the system load Psys.

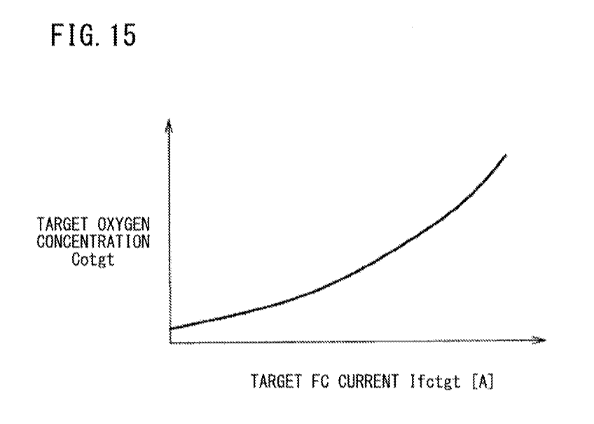

In step S33, the ECU 24 calculates the target oxygen concentration Cotgt in correspondence with the target FC current Ifctgt on the premise that the target FC voltage Vfctgt is at the reference electric potential (see FIGS. 11 and 15). FIG. 15 shows the relationship between the target FC current Ifctgt and the target oxygen concentration Cotgt when the FC voltage Vfc is at the reference electric potential.

In step S34, depending on the target oxygen concentration Cotgt, the ECU 24 calculates and sends instruction values to the respective components. The instruction values herein include the rotation number of the air pump 60 (air pump rotation number Nap), the rotation number of the water pump 80 (water pump rotation number Nwp), the opening degree of the back pressure valve 64 (hereinafter referred to as the “back pressure valve opening degree θbp” or the “opening degree θbp”) and the opening degree of the circulation valve 66 (hereinafter referred to as the “circulation valve opening degree θc” or the “opening degree θc”.

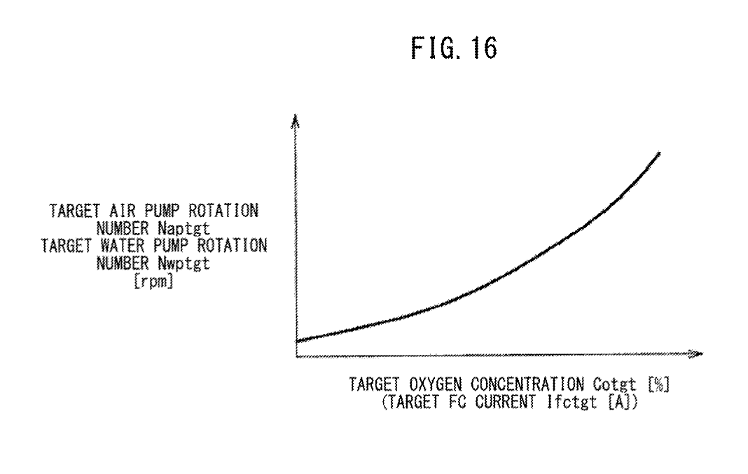

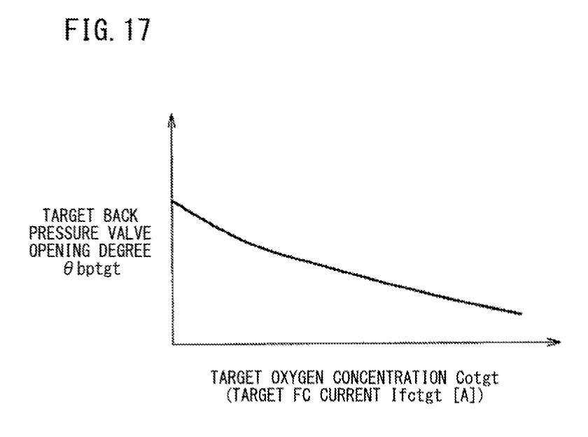

That is, as shown in FIGS. 16 and 17, the target air pump rotation number Naptgt, the target water pump rotation number Nwptgt, and the target back pressure valve opening degree θbptgt are determined depending on the target oxygen concentration Cotgt (or the target FC current Ifctgt). Further, the target opening degree θctgt of the circulation valve 66 is set to an initial value (opening degree where no circulating gas is present).

In step S35, the ECU 24 determines whether power generation by the FC 40 is stably performed or not. In the determination, if the lowest cell voltage inputted from the cell voltage monitor 42 is lower than the voltage obtained by subtracting a predetermined voltage from the average cell voltage (lowest cell voltage<(average cell voltage−predetermined voltage)), the ECU 24 determines that power generation of the FC 40 is not stable. For example, experimental values, simulation values or the like may be used as the predetermined voltage.

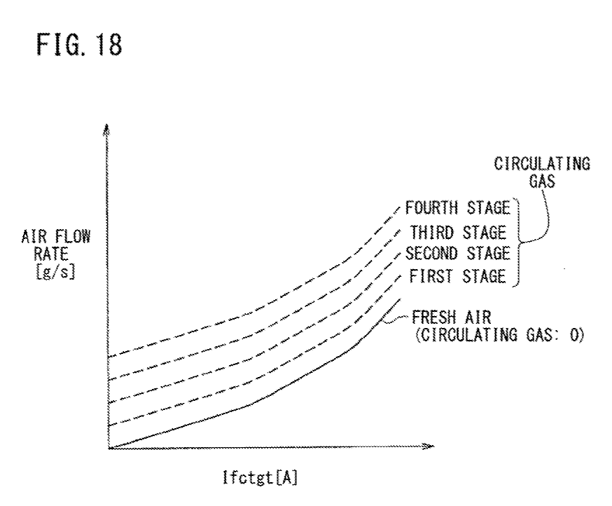

If power generation is stable (S35: YES), the current process is finished. If power generation is not stable (S35: NO), in step S36, the ECU 24 monitors the flow rate Qc [g/s] of the circulating gas through the flow rate sensor 70, increases the opening degree θc of the circulation valve 66, and increases the flow rate Qc by one stage (see FIG. 18). The amount of increase in the circulating gas in each stage is determined appropriately. FIG. 18 shows a case where when the circulation valve 66 is fully opened, the flow rate Qc is increased to the fourth stage, to the maximum flow rate.

When the opening degree θc of the circulation valve 66 is increased, in the suction gas sucked into the air pump 60, the proportion of the circulating gas is increased. That is, in the suction gas, the proportion of the circulating gas is increased in the ratio between the fresh air (air sucked from the outside of the vehicle) and the circulating gas. Therefore, improvement in the capability of distributing oxygen to all the unit cells is achieved. The oxygen-concentration of the circulating gas (cathode off gas) is low in comparison with the oxygen concentration of the fresh air. Therefore, if the rotation number Nap of the air pump 60 and the opening degree θbp of the back pressure valve 64 are the same before and after control of the opening degree θc of the circulation valve 66, the oxygen concentration of the gas flowing through the cathode channel 74 is decreased.

Thus, in step S36, preferably, at least one of the control to increase the rotation number Nap of the air pump 60 and the control to decrease the opening degree θbp of the back pressure valve 64 is implemented in association with the increase in the flow rate Qc of the circulating gas such that the target oxygen concentration Cotgt calculated in step S33 is maintained.

For example, in the case where the flow rate Qc of the circulating gas is increased, it is preferable to increase the rotation number Nap of the air pump 60 thereby to increase the flow rate of the fresh air. By this operation, since the flow rate of the gas (mixed gas of the fresh air and the circulating gas) flowing toward the cathode channel 74 is increased as a whole, further improvement in the capability of distributing oxygen to all the unit cells is achieved, and the power generation performance of the FC 40 can be recovered easily.

In this manner, since the circulating gas is merged with the fresh air while the target oxygen concentration Cotgt is maintained, the volume flow rate (L/s) of the gas flowing through the cathode channel 74 is increased. Thus, since the volume flow rate of the gas is increased while the target oxygen-containing gas concentration Cotgt is maintained, the gas can be distributed smoothly to the entire cathode channel 74 formed in the FC 40 in a complicated manner. The gas can also be supplied to each of the unit cells easily, and instable power generation of the FC 40 can be avoided easily. Further, water droplets (e.g., condensed water) attached to surfaces of MEAs (membrane electrode assemblies) or wall surfaces surrounding the cathode channel 74 can be removed easily.

In step S37, the ECU 24 determines whether or not the flow rate Qc of the circulating gas detected by the flow rate sensor 70 is equal to or more than the upper limit value. The upper limit value serving as the determination criterion is set to a value where the opening degree θc of the circulation valve 66 is fully opened.

In this case, even in a case where the opening degree θc of the circulation valve 66 does not change, if the rotation number Nap of the air pump 60 is increased, the flow rate Qc of the circulating gas detected by the flow rate sensor 70 is increased. Therefore, preferably, the upper limit value is associated with the air pump rotation number Nap, that is, if the rotation number Nap of the air pump 60 becomes large, the upper limit value is increased.

If it is determined that the flow rate Qc of the circulating gas is less than the upper limit (S37: NO), the process returns to step S35. If it is determined that the flow rate Qc of the circulating gas is equal to or more than the upper limit (S37: YES), the process proceeds to step S38.

In steps S36 and S37, the process is carried out based on the flow rate Qc of the circulating gas detected directly by the flow rate sensor 70. Alternatively, the process may be carried out based on the circulation valve opening degree θc. That is, in step S36, the circulating valve opening degree θc may be increased in increments of one stage (e.g., 30°), and in step 37, if the circulation valve 66 is fully opened (S37: YES), the process may proceed to step S38.

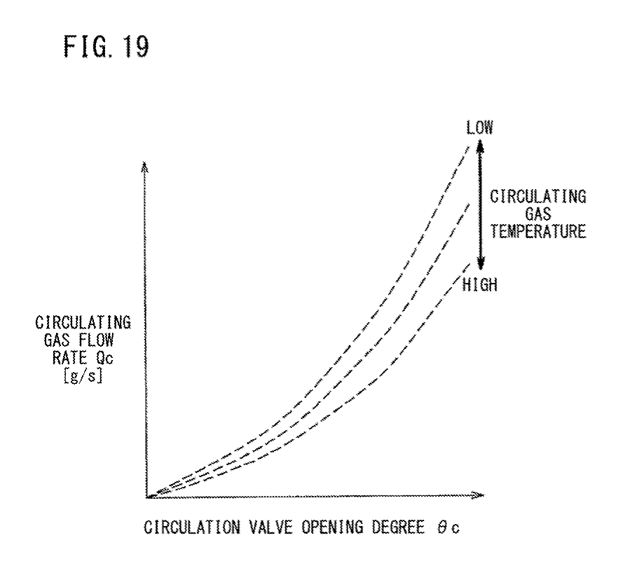

Further, in this case, the flow rate Qc [g/s] of the circulating gas may be calculated based on the opening degree θc of the circulation valve 66, the temperature of the circulating gas, and the map in FIG. 19. In the relationship shown in FIG. 19, as the temperature of the circulating gas increases, the density of the circulating gas becomes low, and thus the flow rate Qc [g/s] becomes low.

In step S38, in the same manner as step S35, the ECU 24 determines whether or not power generation is performed stably. If power generation is performed stably (S38: YES), the current process is finished. If power generation is not performed stably (S38: NO), in step S39, the ECU 24 increase the target oxygen concentration Cotgt by one stage (closer to the normal concentration). More specifically, at least one of increasing the rotation number Nap of the air pump 60 and decreasing the opening degree θbp of the back pressure valve 64 is performed by one stage.

In step S40, the ECU 24 determines whether or not the target oxygen concentration Cotgt is equal to or less than the target oxygen concentration of the normal I-V characteristic (normal oxygen concentration Conml). If the target oxygen concentration Cotgt is equal to or less than the normal oxygen concentration Conml (S40: YES), the process returns to step S38. If the target oxygen concentration Cotgt is more than the normal oxygen concentration Conml (S40: NO), in step 41, the ECU 24 stops operation of the FC unit 18. That is, the ECU 24 stops supply of hydrogen and air to the FC 40 thereby to stop power generation of the FC 40. Then, the ECU 24 turns on an alarming lamp (not shown) to notify the operator that there is a failure in the FC40. It should be noted that the ECU 24 supplies electric power from the battery 20 to the motor 14 for allowing the FC vehicle 10 to continue running.

In the second normal mode as described above, in the case where the system load Psys is relatively low, by adjusting the oxygen concentration Co (cathode stoichiometric ratio) while keeping the FC voltage Vfc at a constant level, basically, the entire system load Psys can be covered with the FC electric power Pfc.

### (2-3-6. First Idling Power Generation Suppression Mode)

As described above, the first idling power generation suppression mode is mainly used in the case where charging of the battery 20 is required during the idling power generation suppression mode. The target cell voltage Vcelltgt (=target FC voltage Vfctgt/cell number) is fixed to an electric potential (in the first embodiment, the electric potential v3 (=0.9V)) outside the oxidation reduction region R3, and the FC current Ifc is fixed. The shortage of the FC electric power Pfc is supplemented with assistance of the battery 20, and excessive electric power of the FC electric power Pfc is used for charging the battery 20. The target oxygen concentration Cotgt is fixed to the normal oxygen concentration Conml (or oxygen is kept in a rich state).

That is, as shown in FIG. 11, in the first idling power generation suppression mode, in a state where the FC 40 has the normal current-voltage characteristic (I-V characteristic as indicated by a solid line in FIG. 11), the cell voltage Vcell is fixed to the electric potential v3 (=0.9V) (The FC voltage Vfc is defined as electric potential v3×cell number). In order to maintain the current-voltage characteristic (I-V characteristic) of the FC 40 in a normal one, the ECU 24 sets the normal oxygen concentration Conml as the target oxygen concentration Cotgt, and sets the rotation number Nap of the air pump 60, the rotation number Nwp of the water pump 80, the opening degree θbp of the back pressure valve 64, and the opening degree θc of the circulation valve 66 depending on this target oxygen concentration Cotgt. Further, in order to fix the cell voltage Vcell at the electric potential v3, the ECU 24 elevates the secondary voltage V2 by the DC/DC converter 22 such that the FC voltage Vfc is adjusted to the electric potential v3×cell number.

In the first idling power generation suppression mode as described above, in the case where the idling power generation suppression mode is selected, the FC 40 can be placed in a standby state while suppressing the FC electric power Pfc, suppressing degradation, and charging the battery 20.

### (2-3-7. Second Idling Power Generation Suppression Mode)

As described above, the second idling power generation suppression mode is mainly used in the case where charging of the battery 20 is not required during an idling power generation suppression mode. The target cell voltage Vcelltgt (=target FC voltage Vfctgt/cell number) is fixed to the electric potential (in the first embodiment, the electric potential v3 (=0.9V)) of the oxidation reduction region R3 or more, and the target oxygen concentration Cotgt is variable. Thus, the FC current Ifc is made variable. Accordingly, the FC electric power Pfc can be changed in accordance with the system load Psys. The shortage of the FC electric power Pfc is supplemented with assistance of the battery 20, and excessive electric power of the FC electric power Pfc is used for charging the battery 20.

That is, as shown in FIG. 11, in the second idling power generation suppression mode, in the state where the cell voltage Vcell is kept at a constant level, the target oxygen concentration Cotgt is decreased thereby to decrease oxygen concentration Co. As shown in FIG. 13, when the oxygen concentration Co (cathode stoichiometric ratio) is decreased, the cell current Icell (FC current Ifc) is accordingly decreased. Thus, by adjusting the target oxygen concentration Cotgt in the state where the cell voltage Vcell is kept at a constant level, it becomes possible to control the cell current Icell (FC current Ifc) and the FC electric power Pfc. The shortage of the FC electric power Pfc is supplemented with assistance of the battery 20.

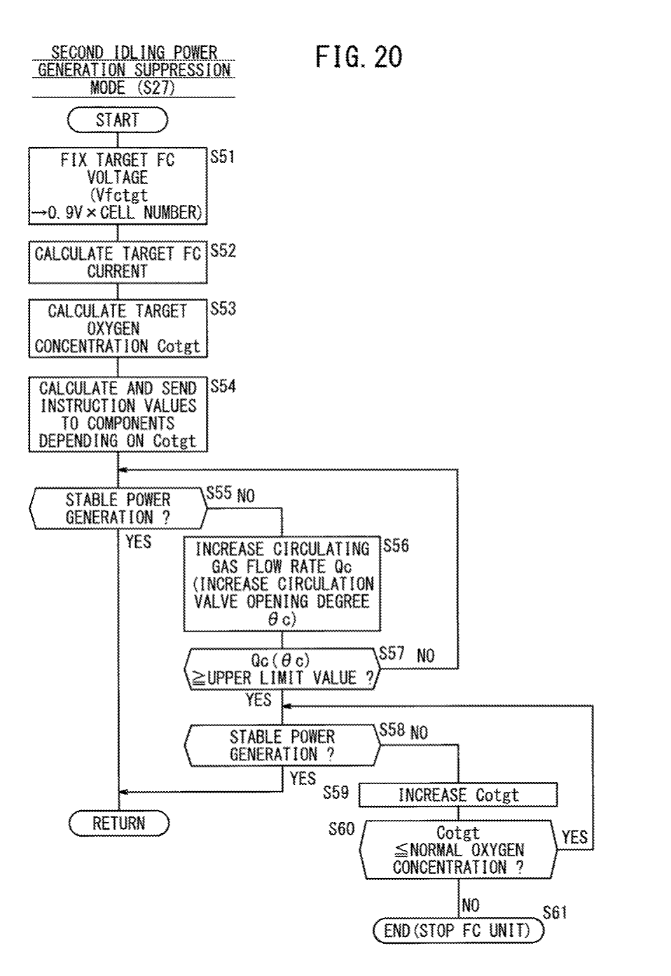

FIG. 20 is a flow chart of the second idling power generation suppression mode. In step S51, the ECU 24 adjusts the voltage elevating rate of the DC/DC converter 22 thereby to fix the target FC voltage Vfctgt to a second reference electric potential×cell number, the second reference electric potential being set to be equal to or larger than the oxidation reduction region R3 (in the first embodiment, the electric potential v3 (=0.9V)). Steps S52 to S61 are performed in the same manner as steps S32 to S41 of FIG. 14.

In the second idling power generation suppression mode as described above, in the case where the idling power generation suppression mode is selected, the FC 40 can be placed in a standby state while suppressing the FC electric power Pfc and suppressing degradation.

### [2-4. FC Power Generation Control]

As described above, as FC power generation control (S4 of FIG. 5), the ECU 24 controls peripheral devices of the FC stack 40, i.e., the air pump 60, the back pressure valve 64, the circulation valve 66, and the water pump 80. Specifically, the ECU 24 controls these devices using instruction values (e.g., S34 of FIG. 14) calculated in energy management (S3 of FIG. 5).

### [2-5. Torque Control of Motor 14]

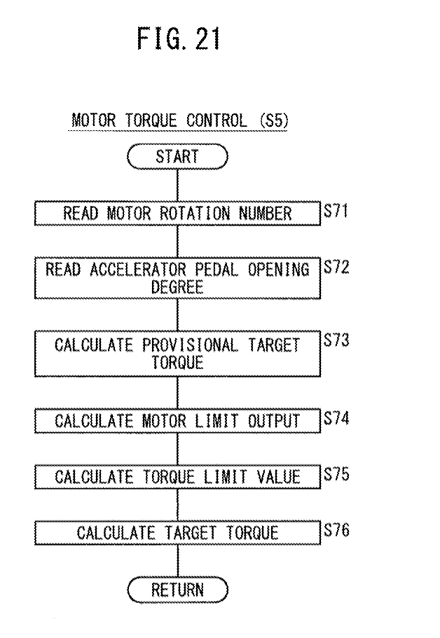

FIG. 21 is a flow chart of torque control of the motor 14. In step S71, the ECU 24 reads the motor rotation number Nm from the rotation number sensor 152. In step S72, the ECU 24 reads the opening degree θp of the accelerator pedal 156 from the opening degree sensor 150.

In step S73, the ECU 24 calculates the provisional target torque Ttgt_p [N·m] of the motor 14 based on the motor rotation number Nm and the opening degree θp. Specifically, a map of data indicating association of the rotation number Nm and the opening degree θp with the provisional target torque Ttgt_p is stored in memory means (not shown), and the provisional target torque Ttgt_p is calculated based on the map, the rotation number Nm, and the opening degree θp.

In step S74, the ECU 24 calculates a limit output (motor limit output Pm_lim) [W] of the motor 14, which is equal to the limit value (limit supply electric power Ps_lim) [W] of the electric power which can be supplied from the FC system 12 to the motor 14. Specifically, the limit supply electric power Ps_lim and the motor limit output Pm_lim can be calculated by subtracting electric power Pa consumed by the auxiliary devices from the sum of the FC electric power Pfc from the FC stack 40 and the limit value (limit output Pbat_lim) [W] of electric power which can be supplied from the battery 20 (Pm_lim=Ps_lim←Pfc+Pbt_lim−Pa).

In step S75, the ECU 24 calculates the torque limit value Tlim [N·m] of the motor 14. Specifically, a value calculated by dividing the motor limit output Pm_lim by the vehicle velocity V is used as the torque limit value Tlim (Tlim←Pm_lim/V).

In step S74, if the ECU 24 determines that the motor 14 is regenerating electric power, the ECU 24 calculates a limit supply regenerative electric power Ps_reglim. The limit supply regenerative electric power Ps_reglim is calculated by subtracting electric power Pa consumed by the auxiliary devices from the sum of the limit value of electric power with which the battery 20 can be charged (limit charging electric power Pbat_chglim) and the FC electric power Pfc from the FC 40 (Pm_reglim=Pbat_chglim+Pfc−Pa). During regeneration of electric power, in step S75, the ECU 24 calculates the regenerative torque limit value Treglim [N·m] of the motor 14. Specifically, a value calculated by dividing the limit supply regenerative electric power Ps reglim by the vehicle velocity Vs (Tlim←Ps_reglim/Vs) is defined as the torque limit value Tlim.

In step S76, the ECU 24 calculates the target torque Ttgt [N·m]. Specifically, the ECU 24 determines the target torque Ttgt by adding a limitation based on the torque limit value Tlim to the provisional target torque Ttgt_p. For example, if the provisional target torque Ttgt_p is equal to or less than the torque limit value Tlim (Ttgt_p≦Tlim), the provisional target torque Ttgt_p is directly used as the target torque Ttgt (Ttgt←Ttgt_p). If the provisional target torque Ttgt_p exceeds the torque limit value Tlim (Ttgt_p>Tlim), the torque limit value Tlim is used as the target torque Ttgt (Ttgt←Tlim).

Then, the motor 14 is controlled using the calculated target torque Ttgt.

### 3. Examples of Various Controls

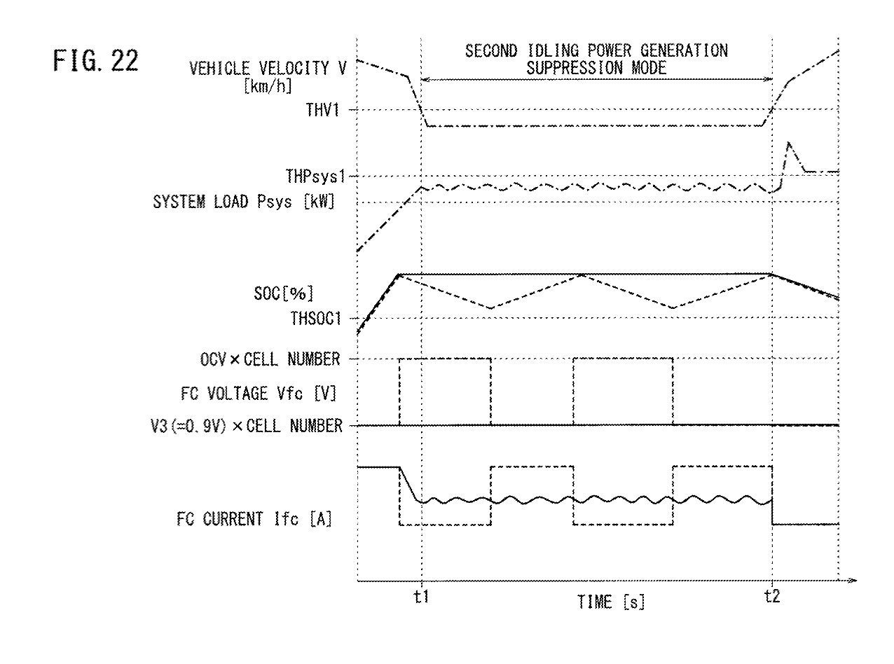

FIG. 22 is a time chart showing examples in the case where various controls according to the first embodiment and a comparative example are used. Those denoted by solid lines in FIG. 22 are based on the controls according to the first embodiment, and those denoted by broken lines are based on the controls according to the comparative example, and those denoted by dashed-dotted lines are common to the first embodiment and the comparative example. The controls according to the comparative example are based on JP2011-015580A.

At time t1, since the vehicle speed V is equal to or less than the threshold value THV1, the system load Psys is equal to or less than the threshold value THPsys1 (S21 of FIG. 12: YES), and the SOC is equal to or more than the threshold value THSOC1 (S25: NO), in the first embodiment, the second idling power generation suppression mode is selected (S27). Therefore, the cell voltage Vcell is fixed to the electric potential v3, and the cell current Icell is constant (FC voltage Vfc is fixed to the electric potential v3×cell number, and the FC current Ifc is constant.). In contrast, in the comparative example, since the electric potential v3×cell number and OCV×cell number are repeated, degradation D is large, e.g., because the cell voltage Vcell changes to pass OCV.

At time t2, since the vehicle speed V exceeds the threshold value THV1 (S21 of FIG. 12: NO), the ECU 24 finishes the second idling power generation suppression mode.

### 4. Advantages of First Embodiment

As described above, in the second idling power generation suppression mode of the first embodiment, the FC current Ifc is changed in accordance with the system load Psys while the FC voltage Vfc being kept at a constant level, i.e., at the electric potential v3×cell number, the electric potential v3 being above the platinum oxidation reduction region R3. Thus, degradation of the FC 40 in the idling power generation suppression mode of the FC 40 is prevented, and unwanted power generation can be suppressed. Accordingly, loss due to charging/discharging of the battery 20 is suppressed, and improvement in the output efficiency in the FC system 12 is achieved.

In the first embodiment, in the case where SOC of the battery 20 is equal to or less than the threshold value THSOC1 (S25 in FIG. 12: YES), the FC voltage Vfc is set to the electric potential v3×cell number until the SOC reaches the threshold value THSOC 1, and the gas in the FC 40 is kept in a rich state (S26). In the structure, since the FC voltage Vfc is set to the electric potential v3×cell number, degradation of the FC 40 can be prevented. Additionally, since the gas in the FC 40 is kept in a rich state, the FC electric power Pfc is increased, and the battery 20 is charged with the excessive electric power thereby to maintain the SOC at the threshold value THSOC1.

In the first embodiment, the FC system 12 is mounted in the FC vehicle 10. Thus, durability of the FC vehicle 10 is improved, and efficiency in operation of the FC vehicle 10 is improved advantageously.

### B. Second Embodiment

In the second embodiment, basically, hardware structure identical to that of the first embodiment is adopted. Hereinafter, like reference numerals designate like elements. In the second embodiment, the ECU 24 uses a method of energy management of the FC system 12 which is different from the method of the first embodiment.

### 1. Energy Management of FC System 12

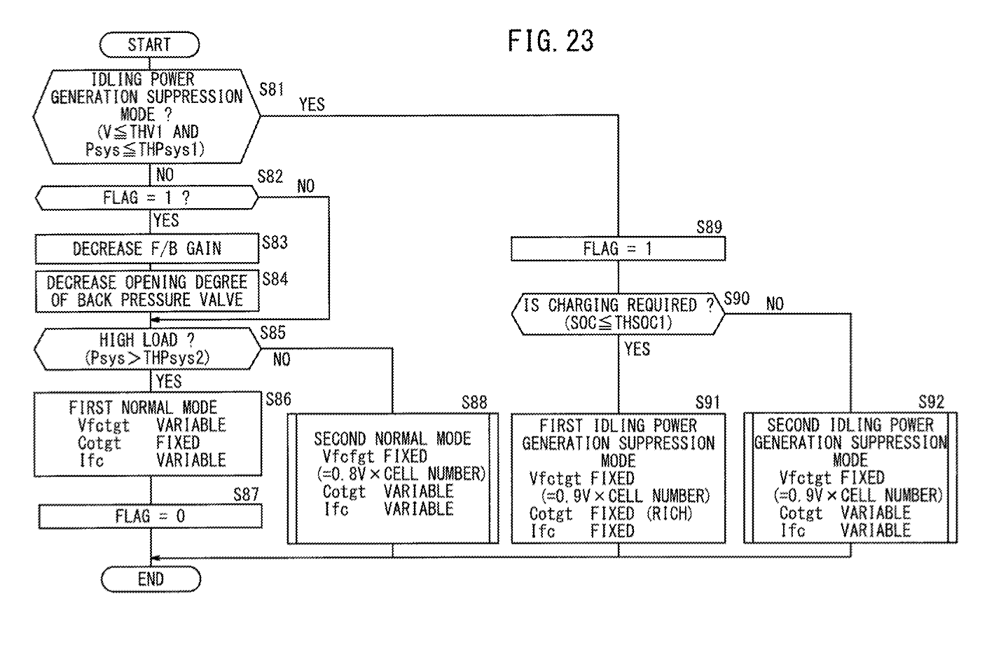

FIG. 23 is a flow chart where the ECU 24 performs energy management (S3 of FIG. 5) of the FC system 12. As in the case of step S21 of FIG. 12, in step S81, the ECU 24 determines whether or not the idling power generation suppression mode should be selected. Specifically, as a condition of the idling power generation suppression mode, the ECU 24 determines whether or not the vehicle velocity V is equal to or less than the threshold value THV1 and the system load Psys is equal to or less than the threshold value THPsys1. If the vehicle velocity V is more than the threshold value THV1 or the system load Psys is more than the threshold value THPsys1 (S81: NO), the process proceeds to step S82.

In step S82, ECU 24 determines whether or not the idling power generation suppression flag (referred to as the “flag” in FIG. 23) is 1. The idling power generation suppression flag indicates whether or not the FC system 12 is in the idling state or in the normal state immediately after recovery from the idling state. More specifically, if the idling power generation suppression flag is 0, the flag indicates that the FC system 12 is neither in the idling state nor in the normal state immediately after recovery from the idling state. If the idling power generation suppression flag is 1, the flag indicates that the FC system 12 is in the idling state or in the normal state immediately after recovery from the idling state.

In step S82, if the idling power generation suppression flag is not 1 (S82: NO), the process proceeds to step S85. If the idling power generation suppression flag is 1 (S82: YES), in step S83, the ECU 24 decreases the feedback gain (hereinafter referred to as the “F/B gain”) for a predetermined time T1.

The F/B gain is a value used in feedback control of the secondary voltage V2. That is, in the second embodiment, as in the case of the first embodiment, the primary voltage V1 is elevated by the DC/DC converter 22 such that the secondary voltage V2 is adjusted to the target FC voltage Vfctgt. At this time, feedback control is used to reduce the error ΔV2 between the secondary voltage V2 and the target FC voltage Vfctgt (target secondary voltage V2).

More specifically, proportional-integral-derivative control (PID control) using the error ΔV2 is performed. Based on the error ΔV2 after PID control, the duty of the DC/DC converter 22 is determined. The F/B gain is used as the proportional term of the PID control. Therefore, if the F/B gain is large, the subsequent variation of the secondary voltage V2 becomes large. If the F/B gain is small, the subsequent variation of the secondary voltage V2 becomes small.

Further, the predetermined time T1 is set in correspondence with the transition period during which the FC 40 transitions from the idling state to the normal state. That is, in the transition period, the error ΔV2 tends to be large. If the magnitude of the F/B gain is kept unchanged, fluctuation of the FC voltage Vfc becomes large. In general, if the FC voltage Vfc changes sharply, the FC 40 tends to be degraded easily. Therefore, in the second embodiment, such degradation is avoided by decreasing the F/B gain in the transition period from the idling state to the normal state.

Thereafter, in step S84, the ECU 24 decreases the back pressure valve opening degree θbp to move the back pressure valve 64 in a closing direction. In this manner, the pressure of the air in the cathode channel 74 is increased, and the oxygen concentration Co (volume concentration) per volume flow rate becomes high. Thus, recovery from the idling state to the normal state can be performed rapidly.

Steps S85, S86, S88 are the same as steps S22, S23 and S24 of FIG. 12. That is, in step S85, the ECU 24 determines whether or not the system load Psys exceeds the threshold value THPsys2 for determining whether or not the system load Psys is high. If the system load Psys exceeds the threshold value THPsys 2 (S85: YES), in step S86, the ECU 24 performs the first normal mode (voltage variable/current variable control).

In a case where the FC system 12 enters the transition period for transitioning from the idling state to the normal state, if the first normal mode is selected in step S86, then it can be considered that the transition period is finished. In this regard, if the first normal mode is selected in step S86, the ECU 24 sets the idling power generation suppression flag at 0 in step S87. As described above, if the idling power generation suppression flag is 1 (S82: YES), then the F/B gain is decreased (S83) and the back pressure valve opening degree Abp is decreased (S84). Therefore, if the idling power generation suppression flag is changed from 1 to 0, this change indicates that the FC 40 has been recovered from the idling state to the normal state.

In step S85, if the system load Psys is the threshold value THPsys2 or less (S85: NO), in step S88, the ECU 24 performs the second normal mode (voltage fixed/current variable control). When the FC 40 enters the transition period for transitioning from the idling state to the normal state, even if the second normal mode is selected in step S88, since the second normal mode is used in the low-load state, it can be considered that the transition period has not yet been finished. Therefore, unlike the case where the first normal mode is selected, even if the second normal mode is selected in step S88, the idling power generation suppression flag is kept to have the value of 1. That is, if the second normal mode is selected in step S88, the process like step S87 is not performed.

In the case where the idling power generation suppression mode is selected in step S81, i.e., in the case where the vehicle velocity V is the threshold value THV1 or less and the system load Psys is the threshold value THPsy1 or less (S81: YES), it can be considered that the FC 40 has entered the idling state or the idling state is going on. Therefore, in step S89, the ECU 24 sets the idling power generation suppression flag to 1.

Steps S90 to S92 are the same as steps S25 to S27 of FIG. 12.

### 2. Examples of Various Controls

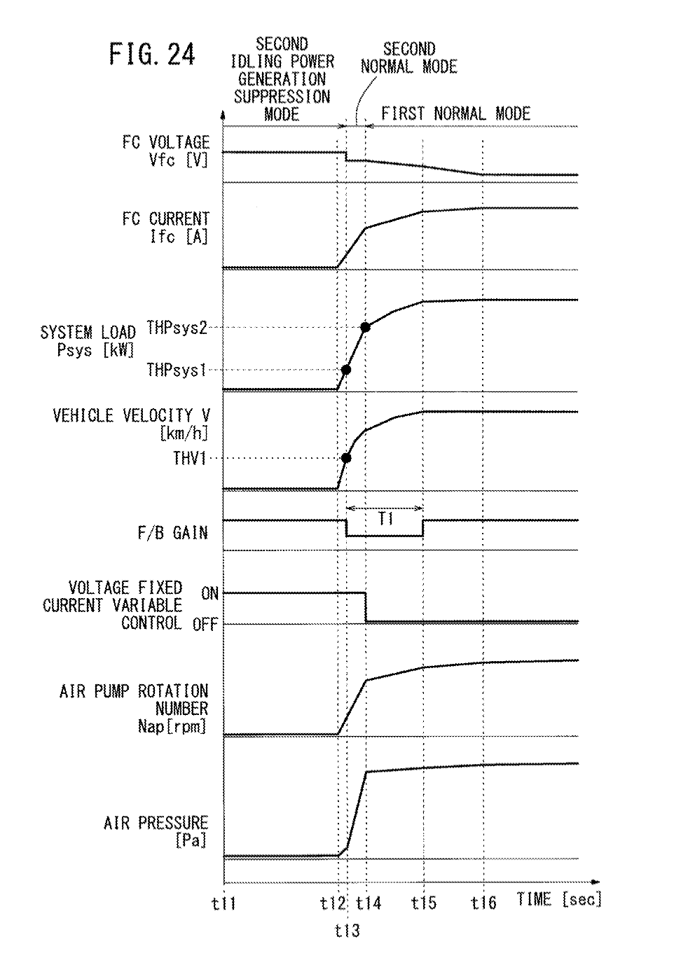

FIG. 24 shows an example of a time chart in a case where various controls according to the second embodiment are used. In FIG. 24, the “air pressure” represents the air pressure in the channel on the cathode side (e.g., the air pressure in the cathode channel 74). The air pressure can be increased by closing the back pressure valve 64 (decreasing the back pressure valve opening degree θbp). Though not shown, it is assumed that the battery SOC exceeds the threshold value THSOC1.

From time t11 to time t12, the vehicle velocity V is the threshold value THV1 or less, and the system load Psys is the threshold value THPsys1 or less (S81 of FIG. 23: YES). Further, as described above, the battery SOC exceeds the threshold value THSOC1 (NO: S90). Therefore, the second idling power generation suppression mode is selected (S92). Thus, the target FC voltage Vfctgt is fixed to the electric potential v3 (=0.9V)×cell number, and the FC current Ifc varies depending on the target oxygen concentration Cotgt. It should be noted that, in FIG. 24, since the system load Psys is constant from time t11 to time t12, the FC current Ifc is accordingly constant.

At time t12, the accelerator pedal 156 is depressed, whereby the system load Psys starts to increase.

Accordingly, the FC current Ifc, the vehicle velocity V, the air pump rotation number Nap, and the air pressure start to increase.

At time t13, the vehicle velocity V exceeds the threshold value THV1, and the system load Psys exceeds the threshold value THPsys1 (S81 of FIG. 23: NO). Since the time t13 is immediately after the entry into the second idling power generation suppression mode, the idling power generation suppression flag is 1 (S89, S82: YES). Thus, the ECU 24 decreases the F/B gain for the predetermined time T1 (S83). In this manner, since the proportional term (P term) used in the PID control for determining the duty of the DC/DC converter 22 is decreased, fluctuation of the secondary voltage V2 and the FC voltage Vfc is suppressed. In FIG. 24, the predetermined time T1 is a period of time from time t13 to time t15.

At time t13, the back pressure valve opening degree θbp is decreased (S84). Thus, the air pressure is increased rapidly. Further, at time t13, since the system load Psys does not exceed the threshold value THPsys2 (S85: NO), the second normal mode is selected (S88). Thus, the target FC voltage Vfctgt is fixed to the electric potential v2 (=0.8V)×cell number, and the FC current Ifc varies in accordance with the target oxygen concentration Cotgt.

At time t14, the system load Psys exceeds the threshold value THPsys2 (S85: YES), and the first normal mode is selected (S86). Thus, the target oxygen concentration Cotgt is fixed, and the target FC voltage Vfc and the FC current Ifc are variable. Further, since the idling power generation suppression flag is switched from 1 to 0 (S87), the voltage fixed/current variable control (second normal mode, the first idling power generation suppression mode, or the second idling power generation suppression mode) is finished. Further, from time t14 to time t16, both of the FC voltage Vfc and the FC current Ifc vary in correspondence with the change in the system load Psys.

### 3. Advantages of Second Embodiment

As described above, in the second embodiment, the FC 40 can transition from the idling state to the normal state rapidly. That is, in general, if the oxygen concentration Co is fixed, in order to increases the FC electric power Pfc, the FC voltage Vfc needs to be decreased, and the FC current Ifc needs to be increased. Further, if the FC voltage Vfc and the FC current Ifc are fixed, by increasing the oxygen concentration Co, it is possible to increase the FC electric power Pfc. In the second embodiment, at the time of transition from the first idling power generation suppression mode or the second idling power generation suppression mode to the first normal mode or the second normal mode, the oxygen concentration Co is increased in accordance with the increase in the system load Psys, and the FC voltage Vfc is decreased in accordance with the increase in the system load Psys. In this manner, since the oxygen concentration Co is increased and the FC voltage Vfc is decreased in accordance with the increase in the system load Psys, the FC 40 can transition from the idling state to the normal state rapidly.

In the second embodiment, at the time of transition from the first idling power generation suppression mode or the second idling power generation suppression mode to the first normal mode or the second normal mode, the F/B gain is decreased (S83) to suppress the change of the FC voltage Vfc. If the FC voltage Vfc is changed rapidly, the FC 40 may be degraded undesirably. However, in the second embodiment, since the rapid fluctuation of the FC voltage Vfc can be suppressed, degradation of the FC 40 can be suppressed.

In the second embodiment, at the time of transition from the first idling power generation suppression mode or the second idling power generation suppression mode to the first normal mode or the second normal mode, the back pressure valve 64 is moved in the closing direction (S84). By moving the back pressure valve 64 in the closing direction, the pressure of the air in the cathode channel 74 is increased, and the oxygen concentration Co (volume concentration) per volume flow rate is increased. Thus, recovery from the idling state to the normal state can be performed rapidly.

### C. Modified embodiment

The present invention is not limited to the above described embodiments. The present invention can adopt various structures based on the description herein. For example, the following structure may be adopted.

### 1. Application of FC System

Though the FC system 12 is mounted in the FC vehicle 10 in the above described embodiments, the present invention is not limited in this respect. The FC system 12 may be mounted in other objects. For example, the FC system 12 may be used in movable objects such as ships or air planes. Alternatively, the FC system 12 may be applied to robots, production apparatus, household power systems, or home electronic appliances.

### 2. Structure of FC System 12

In the embodiments, the FC 40 and the high voltage battery 20 are arranged in parallel, and the DC/DC converter 22 is provided on the near side the battery 20. However, the present invention is not limited in this respect.

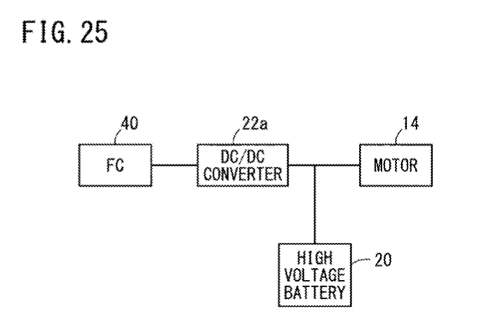

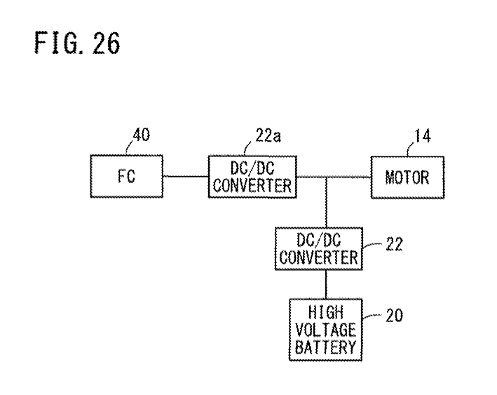

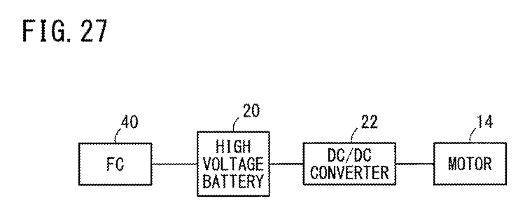

For example, as shown in FIG. 25, the FC 40 and the battery 20 may be provided in parallel, and a step-up, step-down, or step-up/step-down DC/DC converter 22a may be provided on the near side of the FC 40. Alternatively, as shown in FIG. 26, the FC 40 and the battery 20 may be provided in parallel, the DC/DC converter 22a may be provided on the near side of the FC 40, and the DC/DC converter may be provided on the near side of the battery 20. Alternatively, as shown in FIG. 27, the FC 40 and the battery 20 may be provided in series, and the DC/DC converter 22 may be provided between the battery 20 and the motor 14.

### 3. Stoichiometric Ratio

In the above described embodiments, a means or a method of adjusting the stoichiometric ratio is performed by adjusting the target oxygen concentration Cotgt. However, the present invention is not limited in this respect. Alternatively, target hydrogen concentration may be adjusted. Further, instead of the target concentration, the target flow rate, or both of the target concentration and the target flow rate may be adjusted.

In the above described embodiments, a structure including the air pump 60 for supplying air containing oxygen is illustrated. Alternatively or additionally, a structure including a hydrogen pump for supplying hydrogen may be adopted.

In the above described embodiments, a structure including a merging channel (pipes 66a, 66b) for merging the cathode off gas with the fresh air, and the circulation valve 66 is illustrated. Alternatively or additionally, the anode side may have the same structure. For example, a circulation valve may be provided in the pipe 48b for controlling the flow rate of the anode off gas merged with fresh hydrogen by the circulation valve.

### 4. Power Supply Mode

In the above described embodiments, the target FC voltage Vfctgt in the first idling power generation suppression mode and the second idling power generation suppression mode is the electric potential v3 (=0.9V)×cell number. The target FC voltage Vfctgt may be set such that the cell voltage Vcell has a value within the reduction region R2 or within the oxidation region R4. For example, the target FC voltage Vfctgt in one or both of the first idling power generation suppression mode and the second power generation suppression mode may be the electric potential v2 (=0.8V)×cell number. In this case, at the time of transition from the first idling power generation suppression mode or the second idling power generation suppression mode to the first normal mode or the second normal mode, the FC voltage Vfc does not pass through the oxidation reduction region R3. Thus, degradation of the FC 40 which may occur when the FC voltage Vfc passes through the oxidation reduction region R3 can be prevented.

In the second embodiment, at the time of transition from the first idling power generation suppression mode or the second idling power generation suppression mode to the first normal mode or the second normal mode, the F/B gain is decreased to suppress the change in the FC voltage Vfc. However, the method of suppressing the change in the FC voltage Vfc is not limited in this respect. For example, the ECU 24 may limit the amount of change in the target FC voltage Vfctgt (or the target secondary voltage V2tgt) to suppress the change in the FC voltage Vfc.

While the invention has been particularly shown and described with reference to preferred embodiments, it will be understood that variations and modifications can be effected thereto by those skilled in the art without departing from the spirit of the invention as defined by the appended claims.

What is claimed is:

1. A method of controlling a fuel cell system comprising: a fuel cell; an energy storage device for storing electric power supplied from the fuel cell; a load to which electric power is supplied from at least one of the fuel cell and the energy storage device; a converter for adjusting the voltage of the fuel cell; a control device for controlling electric power supplied from the fuel cell and the energy storage device to the load based on electric power required by the load; and a reactant gas supply apparatus for supplying a reactant gas to the fuel cell, the method comprising: by use of the control device,
if it is determined that a condition of an idling power generation suppression mode of the fuel cell is satisfied, setting the voltage of the fuel cell to a predetermined voltage value outside a voltage range where an oxidation-reduction of platinum proceeds, and controlling the reactant gas supply apparatus to change a supply amount of air such that the fuel cell has an output in accordance with the electric power required by the load.

2. The method of controlling the fuel cell system according to claim 1, wherein the predetermined voltage value is above the voltage range where the oxidation-reduction of platinum proceeds.

3. The method of controlling the fuel cell system according to claim 1, further comprising:
if an amount of electric power stored in the energy storage device is a target energy storage amount or less, keeping the voltage of the fuel cell at the predetermined voltage value until the amount of electric power stored in the energy storage device reaches the target energy storage amount, and keeping a gas in the fuel cell in a rich state.

4. The method of controlling the fuel cell system according to claim 1, wherein the fuel cell system is mounted in a vehicle; and
the load includes a regenerative motor and an auxiliary device;
the method further comprising: by use of the control device,
if it is determined that the condition of the idling power generation suppression mode is satisfied, setting the voltage of the fuel cell to the predetermined voltage value, and controlling the reactant gas supply apparatus to change a supply amount of air such that the fuel cell has an output in accordance with the electric power required by the auxiliary device.

5. The method of controlling the fuel cell system according to claim 4, further comprising: by use of the control device,
if the velocity of the vehicle or the rotation number of the motor is a predetermined threshold value or less, setting the voltage of the fuel cell to the predetermined voltage value, and controlling the reactant gas supply apparatus to change a supply amount of air such that the fuel cell has an output in accordance with the electric power required by the auxiliary device.

6. A method of controlling a fuel cell system comprising: a fuel cell; an energy storage device for storing electric power supplied from the fuel cell; a load to which electric power is supplied from at least one of the fuel cell and the energy storage device; a converter for adjusting the voltage of the fuel cell; a control device for controlling electric power supplied from the fuel cell and the energy storage device to the load based on electric power required by the load; and a reactant gas supply apparatus for supplying a reactant gas to the fuel cell, the method comprising: by use of the control device,
adjusting the voltage of the fuel cell to selectively perform a normal mode for controlling electric power supplied from the fuel cell to the load and an idling power generation suppression mode for limiting power generation of the fuel cell during low-load operation of the fuel cell system;
in the idling power generation suppression mode, setting the voltage of the fuel cell to a predetermined voltage value outside a voltage range where an oxidation-reduction of platinum proceeds, and performing low-efficiency power generation to limit a supply amount of the reactant gas; and
at the time of transition from the idling power generation suppression mode to the normal mode as a result of increase in electric power required by the load, increasing a supply amount of a reactant gas supplied to the fuel cell in accordance with increase in the electric power required by the load, and decreasing the voltage of the fuel cell set to the predetermined voltage value, from the predetermined voltage value in accordance with increase in the electric power required by the load.

7. The method of controlling the fuel cell system according to claim 6, further comprising:
suppressing voltage change in the fuel cell at the time of transition from the idling power generation suppression mode to the normal mode.

8. The method of controlling the fuel cell system according to claim 6, further comprising:
moving a back pressure valve in a closing direction before transition from the idling power generation suppression mode to the normal mode as a result of increase in the load.
